(19) United States
(12) Patent Application Publication
(10) Pub. No.: US 2016/0139901 A1
(43) Pub. Date: May 19, 2016

(54) SYSTEMS, METHODS, AND COMPUTER PROGRAMS FOR PERFORMING RUNTIME AUTO PARALLELIZATION OF APPLICATION CODE

(71) Applicant: QUALCOMM INCORPORATED, SAN DIEGO, CA (US)

(72) Inventors: CHRISTOS MARGIOLAS, SAN JOSE, CA (US); ROBERT SCOTT DREYER, MENLO PARK, CA (US); JASON KIM, SAN JOSE, CA (US); MICHAEL DOUGLAS SHARP, LOS GATOS, CA (US)

(21) Appl. No.: 14/620,513

(22) Filed: Feb. 12, 2015

Related U.S. Application Data
(60) Provisional application No. 62/081,465, filed on Nov. 18, 2014.

(51) Int. Cl. G06F 9/45; G06F 9/44

(52) U.S. Cl. CPC G06F 8/452; G06F 8/70

(57) ABSTRACT

Systems, methods, and computer programs are disclosed for performing runtime auto-parallelization of application code. One embodiment of such a method comprises receiving application code to be executed in a multi-processor system. The application code comprises an injected code cost computation expression for at least one loop in the application code defining a serial workload for processing the loop. A runtime profitability check of the loop is performed based on the injected code cost computation expression to determine whether the serial workload can be profitably parallelized. If the serial workload can be profitably parallelized, the loop is executed in parallel using two or more processors in the multi-processor system.

### CROSS-REFERENCE TO RELATED APPLICATIONS

This application claims the benefit of the priority of U.S. Provisional Patent Application No. 62/081,465, entitled “Systems, Methods, and Computer Programs for Performing Runtime Auto-Parallelization of Application Code,” filed on Nov. 18, 2014 (Attorney Docket No. 17006.0379U1), which is hereby incorporated by reference in its entirety.

### DESCRIPTION OF THE RELATED ART

Portable computing devices (e.g., cellular telephones, smart phones, tablet computers, portable digital assistants (PDAs), and portable game consoles) continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising one or more chip components embedded on a single substrate (e.g., a plurality of central processing units (CPUs), graphics processing units (GPU), digital signal processors, etc.).

It is desirable for such multi-processor devices or other computing systems (e.g., desktop computers, data server nodes, etc.) to be able to profitably parallelize application code running on the device based on code cost analysis. Existing cost code analysis techniques and solutions for parallelizing application code, however, rely on simple cost heuristics, which may not be able to analyze complex control flow or provide adequate runtime profitability checks.

Accordingly, there is a need in the art for improved systems, methods, and computer programs for providing parallelization of application code at runtime.

### SUMMARY OF THE DISCLOSURE

Various embodiments of methods, systems, and computer programs are disclosed for performing runtime auto-parallelization of application code. One embodiment of such a method comprises receiving application code to be executed in a multi-processor system. The application code comprises an injected code cost computation expression for at least one loop in the application code defining a serial workload for processing the loop. A runtime profitability check of the loop is performed based on the injected code cost computation expression to determine whether the serial workload can be profitably parallelized. If the serial workload can be profitably parallelized, the loop is executed in parallel using two or more processors in the multi-processor system.

Another embodiment is a system for performing runtime auto-parallelization of application code. The system comprises a plurality of processors and a runtime environment configured to execute application code via one or more of the plurality of processors. The runtime environment comprises an auto-parallelization controller configured to receive the application code to be executed via one or more of the processors. The application code comprises an injected code cost computation expression for at least one loop in the application code defining a serial workload for processing the loop. The auto-parallelization controller performs a runtime profitability check of the loop based on the injected code cost computation expression to determine whether the serial workload can be profitably parallelized. If the serial workload can be profitably parallelized, the auto-parallelization controller executes the loop in parallel using two or more processors.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram illustrating an embodiment of a compiler environment and a runtime environment for implementing various aspects of systems, methods, and computer programs for providing runtime auto-parallelization of application code. The left side depicts the program compilation on a development system and the right side depicts a target computing device where runtime auto-parallelization may be performed.

FIG. 2 is functional block diagram of an embodiment of a method for providing runtime auto-parallelization of application code in the working environment of FIG. 1.

FIG. 3 is a functional block diagram illustrating an embodiment of the code cost analysis module(s) incorporated in the compiler environment of FIG. 1.

FIG. 4a is an exemplary embodiment of application code for illustrating operation of the code cost analysis modules of FIG. 3.

FIG. 4b is an embodiment of a directed acyclic graph for representing code costs associated with the application code of FIG. 4a.

FIGS. 5a-5e illustrate an embodiment of a method for computing code cost statically, when all the loop trip counts are constant, on the directed acyclic graph of FIG. 4b.

FIGS. 6a-6e illustrate a first embodiment of a method for constructing runtime code cost computation expressions for the application code of FIG. 4a when the outer loop has a dynamic trip count and the inner loop has a constant trip count.

FIGS. 7a-7e illustrate a second embodiment of a method for constructing runtime code cost computation expressions for the application code of FIG. 4a when the outer loop has a constant trip count and the inner loop has a dynamic trip count.

FIGS. 8a-8e illustrate a third embodiment of a method for constructing runtime code cost computation expressions for the application code of FIG. 4a when both the outer and inner loops have a dynamic trip count.

FIG. 9 is another example of application code for illustrating embodiments where the trip count of the inner loop is defined by the outer loop. The total number of iterations of the inner loop may be represented as the sum of an arithmetic sequence of a method for representing inner loop trip count values as an arithmetic sequence.

FIG. 10 generalizes the example application code of FIG. 9. A number of scalar operations in the body of the outer loop define the trip count of the inner loop. Each iteration of the outer loop defines a new dynamic trip count for the inner loop.

FIG. 11 illustrates an “a₁ computation” associated with the application code of FIG. 10 comprising a computation of the first term of the arithmetic sequence wherein its sum represents the total number of iterations of the inner loop.

FIG. 12 illustrates an “aₙ computation” associated with the application code of FIG. 10 comprising a computation of the last term of the arithmetic sequence wherein its sum represents the total number of iterations of the inner loop.

FIG. 13 indicates the instruction (bold font) of the outer loop body that defines the dynamic trip count of the inner loop for the code first shown in FIG. 9. An embodiment of a method represents the total number of the inner loop iterations as the sum of arithmetic sequence leading to efficient runtime code cost computation.

FIG. 14 illustrates an “a₁ computation” comprising the computation of the first term of the arithmetic sequence that represents the total number of iterations for the inner loop of code of FIG. 13.

FIG. 15 illustrates an “aₙ computation” comprising the computation of the last term of the arithmetic sequence that represents the total number of iterations for the inner loop of the code of FIG. 13.

FIG. 17 is a graph illustrating an exemplary breakeven point for determining whether to run a serial or parallelized version of a loop.

FIGS. 16a-16f illustrate another embodiment of a method for computing runtime code costs when the outer loop has a constant trip count and the inner loop trip count is dependent on the outer loop for cases where outer loops define the dynamic trip counts of the inner loop.

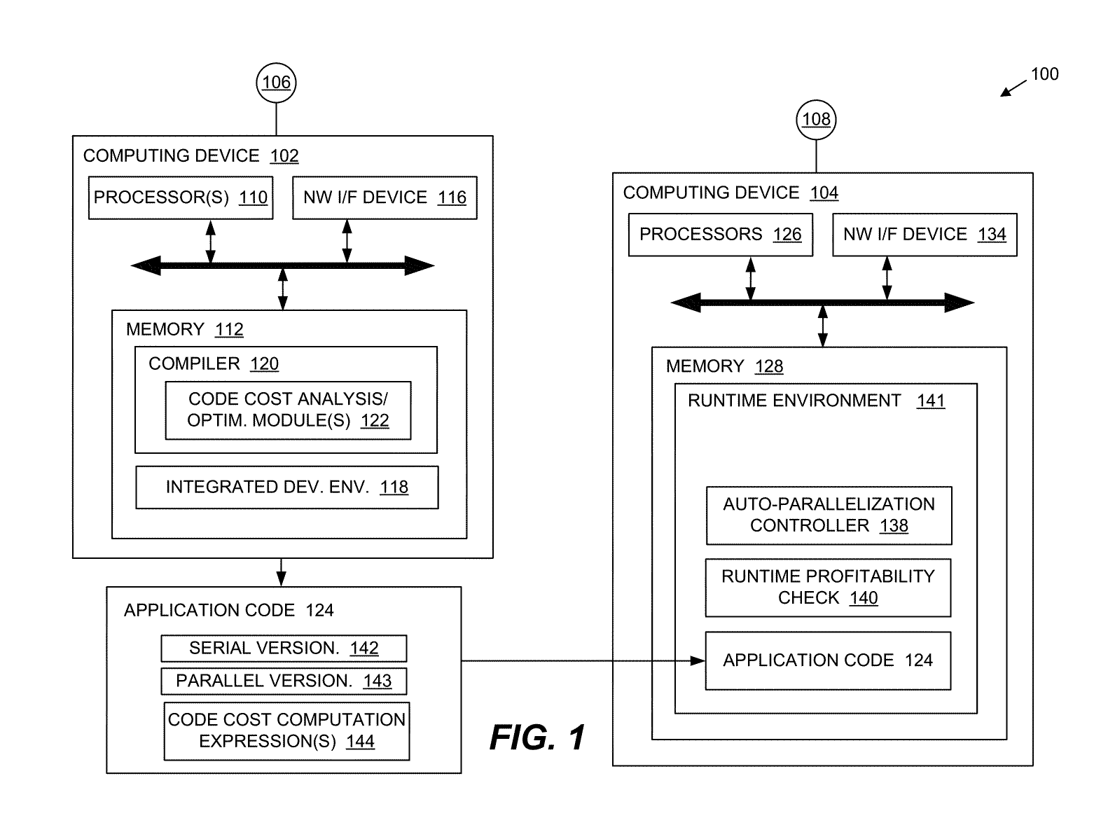

FIG. 18 illustrates the runtime environment of FIG. 1 incorporated in an exemplary portable computing device (PCD).

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

FIG. 1 is a block diagram illustrating an embodiment of a working environment 100 for implementing various aspects of systems, methods, and computer programs for providing cost code analysis and runtime auto-parallelization of application code. The working environment 100 comprises an application development/compile environment and a runtime environment. A computing device 102 or other computer system, which may be used by a developer 106 to develop and compile a computer application, represents the application development/compile environment. A computing device 104, which may be used by an end user 108 to run the computer application, represents the runtime environment. It should be appreciated that the runtime environment and the application development/compile environment may be implemented in any computing device, including a personal computer, a workstation, a server, a portable computing device (PCD), such as a cellular telephone, a portable digital assistant (PDA), a portable game console, a palmtop computer, or a tablet computer.

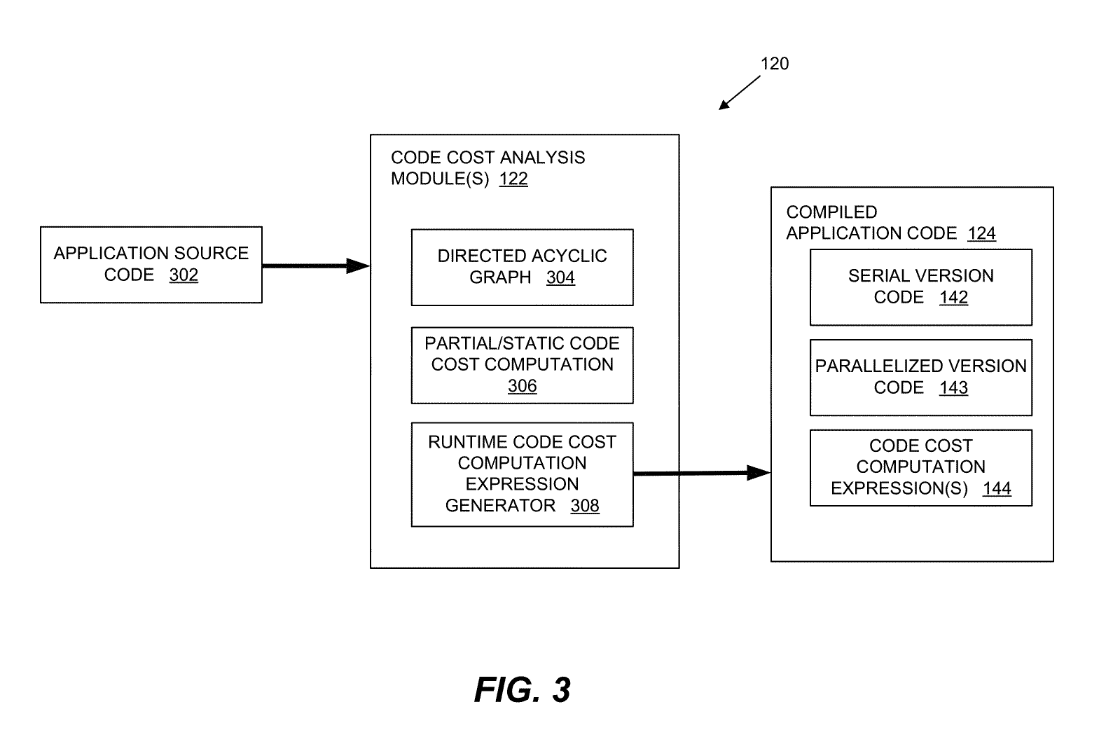

The computing device 102 may comprise one or more processors 110 coupled to a memory 112. The memory 112 may comprise an integrated development environment (IDE) 118. The IDE 118 comprises one or more software applications that provide comprehensive facilities to computer programmers for software development. The IDE 118 may include, for example, a source code editor, various build automation tools, a debugger, and a compiler 120. The compiler 120 may further comprise code cost analysis (CCA) and optimization module(s) 122. The CCA module(s) 122 may execute as part of the compiler's optimization engine. As known in the art, the compiler 120 compiles application source code 302 (FIG. 3) and generates application code 124, which may be accessed, downloaded, or otherwise executed by the computing device 104.

The CCA module(s) 122 comprise the logic and/or functionality for implementing various CCA algorithms configured to process the application source code 302, identify code loops, and compute the code costs associated with the code loops. As described below in more detail, the CCA algorithms may be configured to perform partial or static code cost computations and generate code cost computation expressions 144. The code cost computation expressions 144 are injected into the compiled application code 124 and may be used, at runtime, to determine whether a loop may be profitably parallelized. In this regard, the application code 124 may be compiled with a serial code version 142 and a parallelized code version 143 for code loops. At runtime, the serial code version 142 may be used when a code loop is to be executed using a single processor 126. If the code loop may be profitably parallelized, the parallelized code version 143 may be used to execute the loop in parallel using two or more processors 126.

One of ordinary skill in the art will appreciate that the term “profitable” in the context of application code refers to a more desirable final implementation of application code than an original existing implementation. For example, “profitable” may refer to a final implementation of an application code that runs in less time than the original, consumes less memory than the original, or consumes less power than the original, although there may be other embodiments of profitability based on other desirable goals.

The term “profitably parallelized” refers to a piece of sequentially executed code that may be parallelized or executed in parallel and is expected to demonstrate some measure of profitability as a result.

It should be appreciated that the term “runtime auto-parallelization” may be independent of a specific point in time when auto-parallelization may occur. For example, auto-parallelization may occur at compile time or at runtime. In this description, the term “runtime auto-parallelization” refers to the decision, at runtime, of executing application code either in its original sequential form or in a parallel form. The decision may be, for instance, to always or never execute the parallel form of the application. In other instances, the decision may be made based on information available only at runtime.

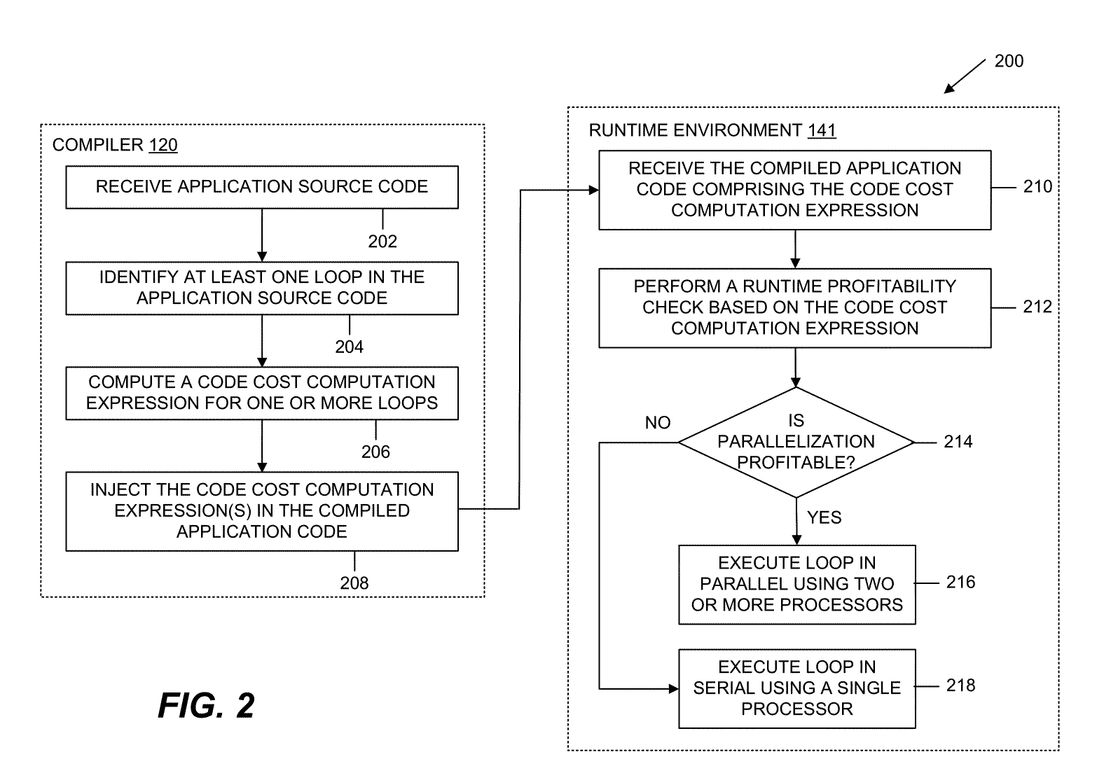

FIG. 2 is functional block diagram of an embodiment of a method 200 for providing runtime auto-parallelization of application code 124. A first portion of the method 200 (blocks 202, 204, 206, and 208) may be performed at compile time by the compiler 120 and/or the CCA module(s) 122. A second portion (blocks 210, 212, 214, 216, and 218) may be performed at runtime by the runtime environment 141. At block 202, the compiler 120 may access the application source code 302 generated via the IDE 118. At block 204, the CCA module(s) 122 may identify loops in the application source code 302. At block 206, the CCA module(s) 122 may perform static code cost estimations and compute the code cost computation expression(s) 144 used at runtime for performing runtime profitability checks 140. At block 208, the code cost computation expressions(s) 144 are injected in the compiled application code 124. It should be appreciated that the application code 124 may be provided to or otherwise accessed by the computing device 104. In an embodiment, the computing device 104 may access the application code 124 via a communications network, such as, the Internet. In this regard, computing device 102 and computing device 104 may further comprise suitable network interface devices 116 and 134, respectively, for facilitating this communication either directly or via other computer devices, systems, networks, etc.

At block 210, the runtime environment 141 receives the compiled application code 124 comprising the code cost computation expression(s) 144 and the serial code version 142 and the parallelized code version 143 for code loops. At block 212, the auto-parallelization controller 138 may perform a runtime profitability check 140 based on the code cost computation expressions 144 injected in the application code 124 by the compiler 120. At decision block 214, the auto-parallelization controller 138 may determine for each code loop whether parallelization will be profitable. If “yes”, at block 216, the auto-parallelization controller 138 may initiate parallel execution of a code loop via two or more processors 126 using, for example, the parallelized code version 143. If “no”, at block 218, the auto-parallelization controller 138 may initiate serial execution of a code loop via a single processor 126 using, for example, the serial code version 142.

In this regard, it should be appreciated that the CCA module(s) 122 and the auto-parallelization controller 138 may support various code cost use cases depending on the nature of the application code, the runtime environment 141, etc. For example, the CCA algorithms may determine that a first type of loop (Loop 1) cannot be parallelized, in which case the runtime environment 141 may always execute Loop 1 using a single processor 126. For a second type of loop (Loop 2), the CCA algorithms may determine that the loop may always be profitably parallelized because, for example, all loop trip counts may be statically resolved. In this use case, the runtime environment 141 may always execute Loop 2 in parallel using two or more processors 126. As described below in more detail, a third use case involves a loop (Loop 3) for which the CCA algorithms cannot statically resolve all loop trip counts. In this scenario, the CCA algorithms compute a code cost computation expression 144 for the Loop 3, which is injected into the application code 144 and used by the runtime environment 144 to perform the runtime profitability check 140 and determine whether the Loop 3 may be profitably parallelized. If based on the runtime profitability check 140 and a number of available processors 126 it is determined that parallelization would be profitable, Loop 3 may be executed in parallel using the available processors 126. If, however, parallelization would not be profitable, Loop 3 may be executed using a single processor 126.

In other words, it should be appreciated that the runtime profitability check 140 determines whether the loop comprises enough work (e.g., instruction cycles, execution time, etc.) such that it may be profitably parallelized. In an embodiment, the runtime profitability check 140 may implement Equation 1 below.

(W/N+O)<W
W=an amount of work in the loop
N=a number of processors available for parallelization
O=overhead of parallelization/optimization

### Equation 1: Exemplary Runtime Profitability Check

If (W/N+O)<W, it is determined that the loop may be profitably parallelized (i.e., Loop 3 type). If (W/N+O) is greater than or equal to W, it is determined that the loop may not be profitably parallelized (i.e., Loop 2 type).

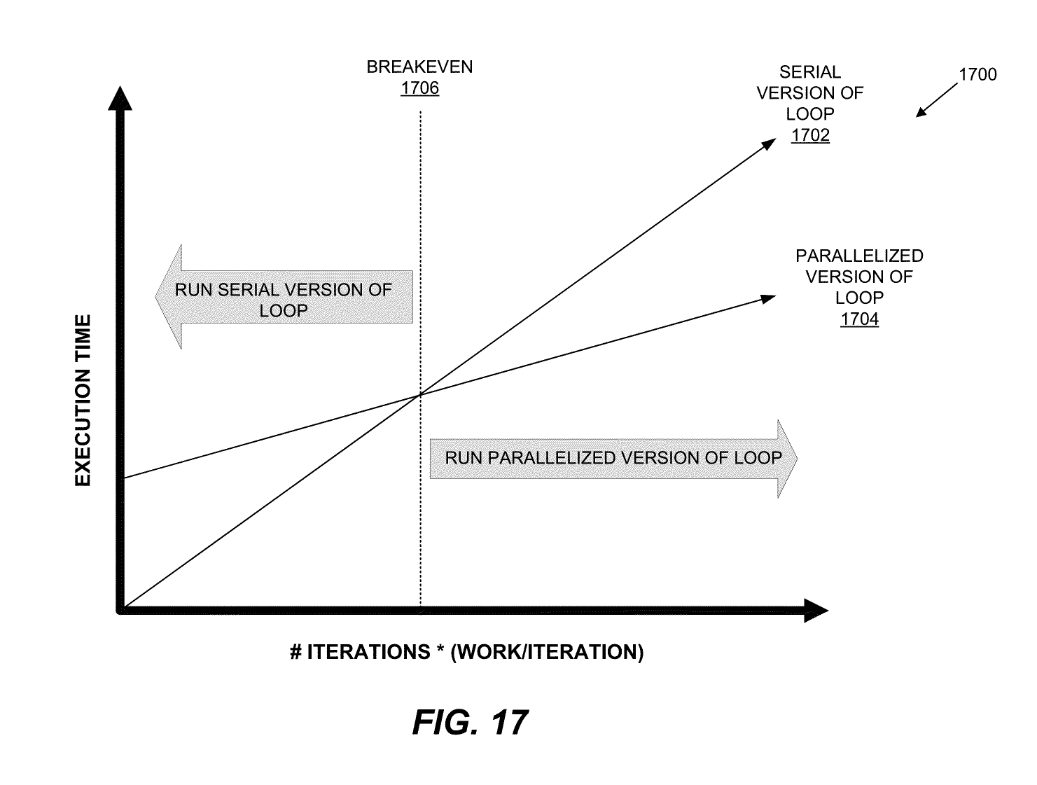

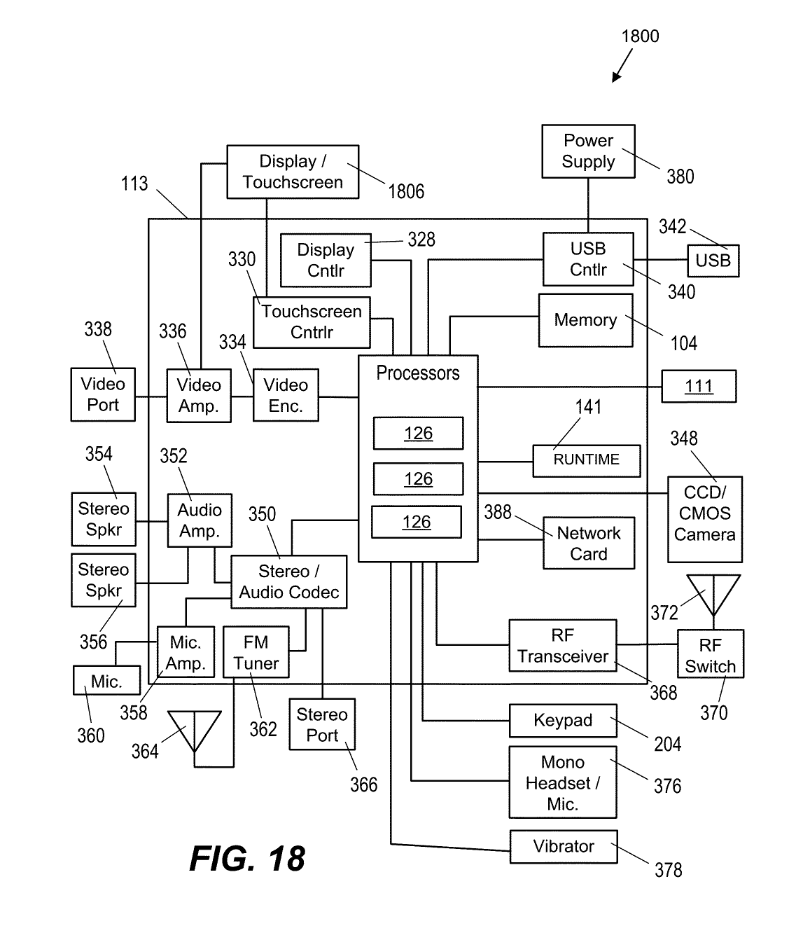

As illustrated in FIG. 17, it should be appreciated that the parallelization overhead (O) may define a breakeven point 1706 on a graph 1700. Graph 1700 illustrates the execution time of a serial version of a loop (line 1702) and a parallelized version of a loop (line 1704) as a function of loop workload (e.g., # iterations*(work/iteration)). The intersection of lines 1702 and 1704 defines the breakeven point 1706. For loop workloads below the breakeven point 1706, the serial version of the loop may be executed. For loop workloads above the breakeven point 1706, the parallelized version of the loop may be executed.

As mentioned above, in certain situations, the amount of work in the loop (W) may be completely determined at compile time. However, if the amount of work in the loop (W) cannot be completely determined at compile time, the CCA algorithms 122 generate the code cost computation expression 144 and inject it into the application code. For example, consider the situation in which the application code 124 comprises a loop for processing a picture/photo to be selected by the user 108. The execution cost (e.g., the number of instructions executed) of the loop may depend on the size of the image selected (e.g., width, height, resolution). The CCA algorithms 122 may generate a code cost computation expression 144 comprising a numerical expression. The numerical expression may be represented according to Equation 2 below.

W=S+R;
W=an amount of work in the loop;
S=a static portion of work computed at compile time (CCA);
R=a dynamic portion of work subject to application runtime

### Equation 2: Exemplary Code Cost Computation Expression

It should be appreciated that the relationship between S and R may vary depending on, for example, loop trips counts, loop execution counts, inter-loop dependences etc. and, therefore, may be represented according to any mathematical formula.

FIG. 3 illustrates an embodiment of the CCA modules 122 for performing partial or static code cost computations and generating the code cost computation expressions 144 that are injected in the application code 124 for performing the runtime profitability check 140. Partial/static code cost computation module(s) 306 are configured to construct a directed acyclic graph 304 based on the application source code 302 and compute partial or static code cost computations. Generator module(s) 308 are configured to compute the code cost computation expressions 144 to be used at runtime to compute runtime code costs.

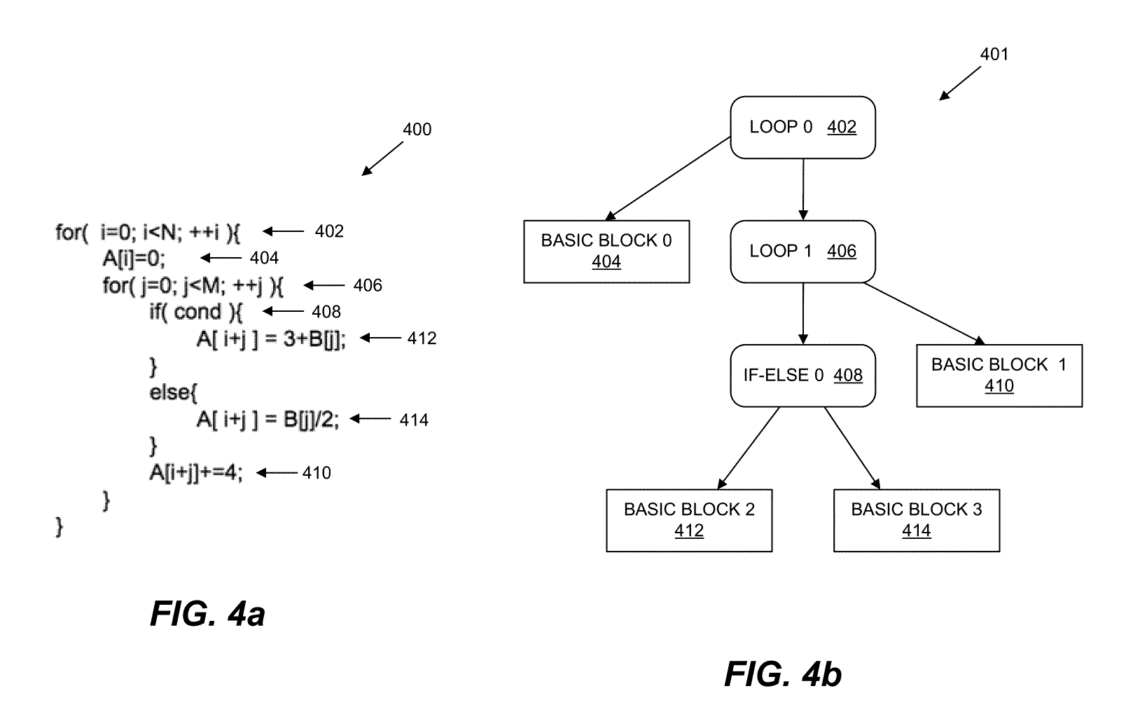

FIG. 4a illustrates exemplary source code 400. FIG. 4b illustrates a directed acyclic graph (DAG) 401 constructed by the CCA modules 122 for representing the source code 401. DAG 401 comprises a plurality of cost unit nodes. A cost unit node may comprise a loop, a conditional construct (e.g., if-else), or a basic block. A directed edge from a node A to a node B denotes that node A contains node B. A loop node is used to represent a loop and may comprise one or more children nodes. A child node may comprise a loop, a conditional construct, or a basic block. A conditional construct represents a diverse control flow comprising two or more children nodes. A child of a conditional construct may be a loop, another conditional construct, or a basic block. A basic block has no children nodes. Loop and conditional construct nodes may embed profiling information that indicates the number of iterations in the case of loops or weights in the case of conditional branches.

In this regard, it should be appreciated that an external profiling process may be implemented for collecting information related to the behavior of the program or application code (referred to as “profiling information”). Profiling information may comprise, for example, total loop trip counts, average loop trip counts, total number of times a branch is taken, probability of a branch begin taken, number of times a function is invoked, and equivalent forms from which such data may be determined. Profiling information may also include other types of information, such as, for example, power consumption information during execution, memory bandwidth requirements, memory access patterns, and hardware counter events. The profiling process may be performed in various ways. In one exemplary implementation, the profiling process may be performed by application code instrumentation made by compiler transformations or external tools, such as, execution tracers, hypervisors, and/or virtual machines.

In the embodiment illustrated in FIGS. 4a & 4b, the DAG 401 comprises an outer loop 402 (Loop 0) having two children nodes: a basic block 404 (Basic Block 0) and an inner loop 406 (Loop 1). The inner loop 406 has two children nodes: abasic block 410 (Basic Block 1) and an if-else construct 408 (If-Else 0). The if-else construct 408 comprises two children nodes: a basic block 412 (Basic Block 2) and a basic block 414 (Basic Block 3).

It should be appreciated that the CCA modules 122 are configured to statically compute as much of the code cost as possible at compile time based on the DAG 401 (referred to as static or partial code cost computations). In an embodiment, the CCA modules 122 compute the cost of each cost unit node in the DAG 401 in a bottom-up manner. The cost of children nodes is aggregated at the parent node level based on the type of node (i.e., loop, conditional, basic block). The cost of a basic block may be determined based on the category of instructions (e.g., computation instructions, write memory access instructions, read memory access instructions, etc.). The cost of an if-else construct may be computed as the minimum cost of the “taken” and the “not taken” paths or, in the presence of profiling information, as a statistical method with the input of profiling information. It should be appreciated that the term “minimum cost” of the “taken” and the “not taken” paths may refer to the use of a statistical method in presence of profiling information. The cost of a loop may be computed as the summation of children costs multiplied by the loop trip count.

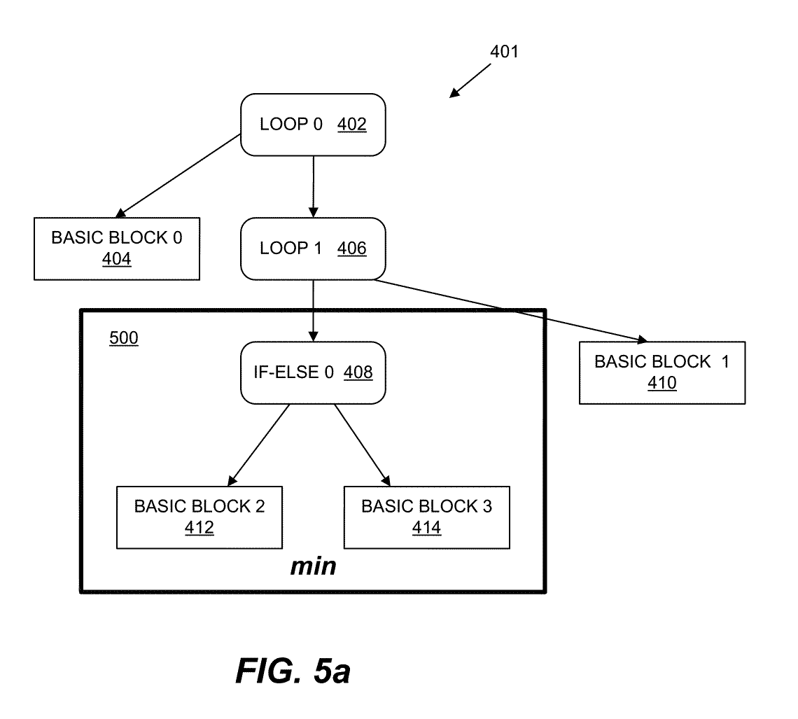

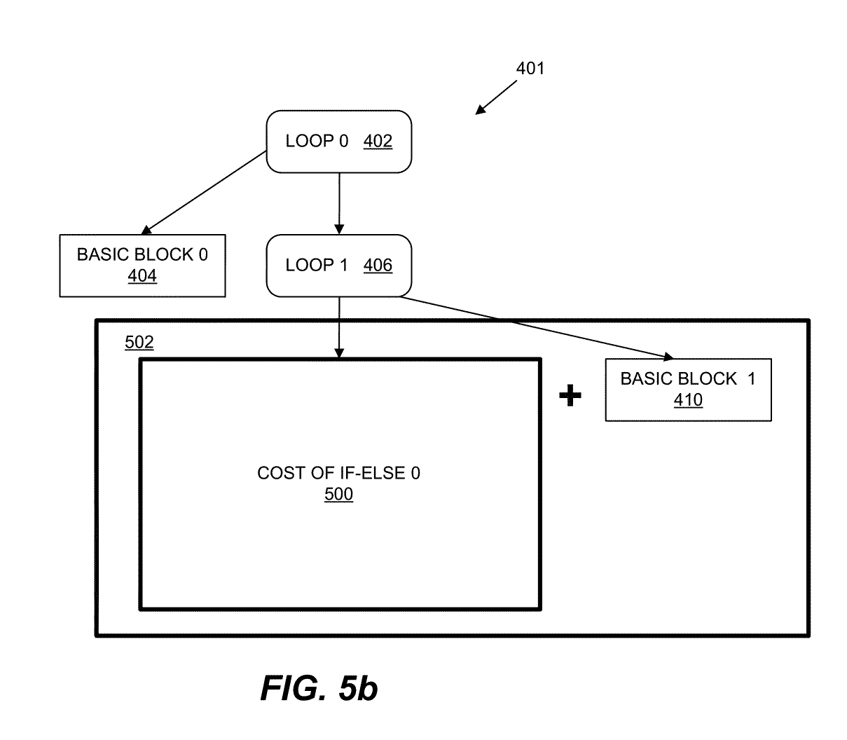

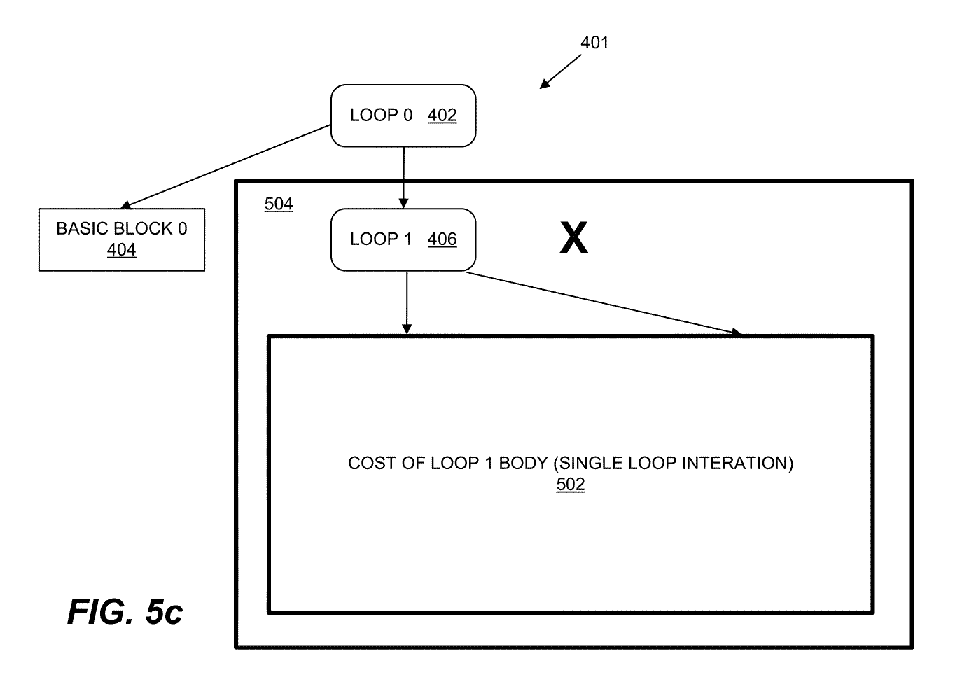

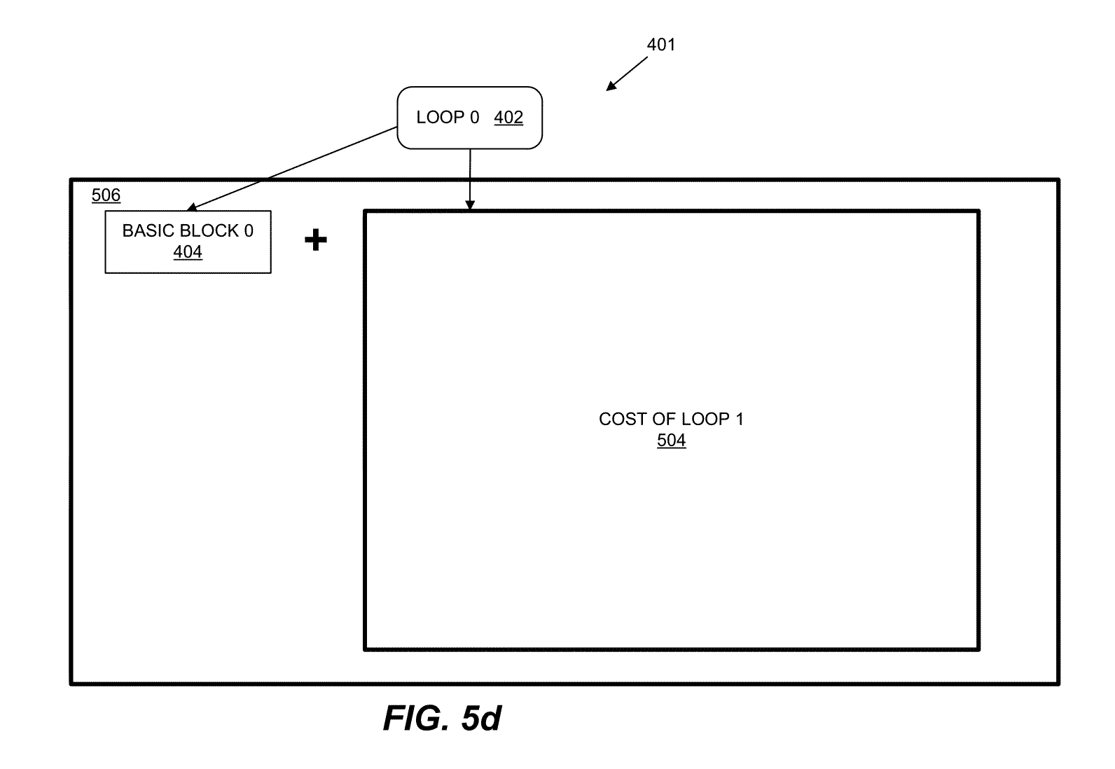

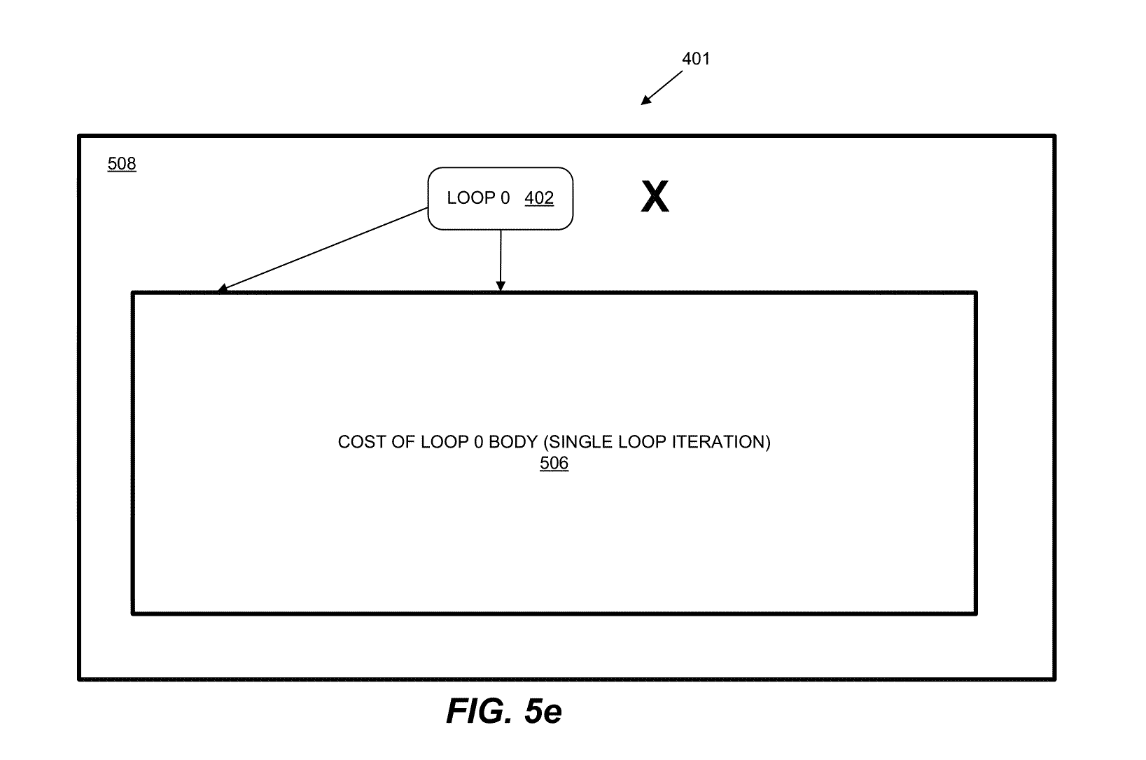

FIGS. 5a-5e illustrate an embodiment of a method for computing static code costs for DAG 401. It should be appreciated that, in this embodiment, the code cost may be completely computed at compile time because all loop trip counts may be statically resolved. Each of FIGS. 5a-5e represent a step in the method, following a bottom-up cost computation process. In FIG. 5a, the cost of If-Else 0 is computed as the minimum cost (cost 500) of Basic Block 2 and Basic Block 3. FIG. 5b, the cost of a single loop iteration of Loop 1 Body (cost 502) is computed as the sum of cost 500 for If-Else 0 and the cost of Basic Block 410. In FIG. 5c, the cost of Loop 1 (cost 504) is computed by multiplying cost 502 (i.e., a single loop iteration of Loop 1 Body) by the Loop 1 Trip Count. In FIG. 5d, the cost of a single loop iteration of Loop 0 Body (cost 506) is computed as the sum of cost 504 and the cost of Basic Block 0 (cost 404). In FIG. 5e, the total cost of Loop 0 (cost 508) is computed by multiplying cost 506 (i.e., a single loop iteration of Loop 0 Body) by Loop 0 Trip Count.

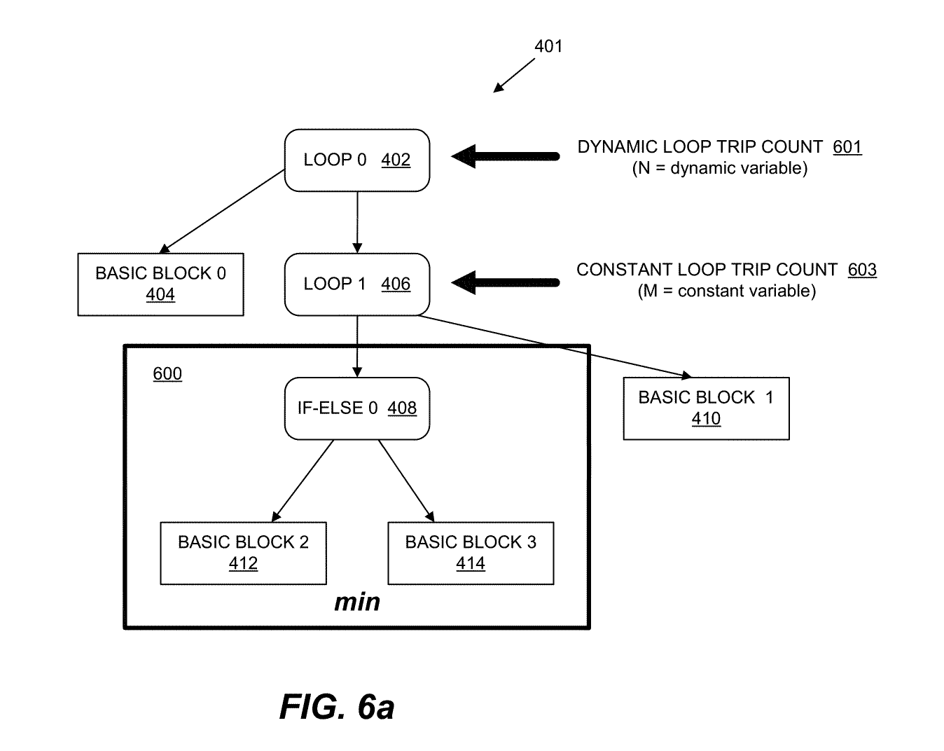

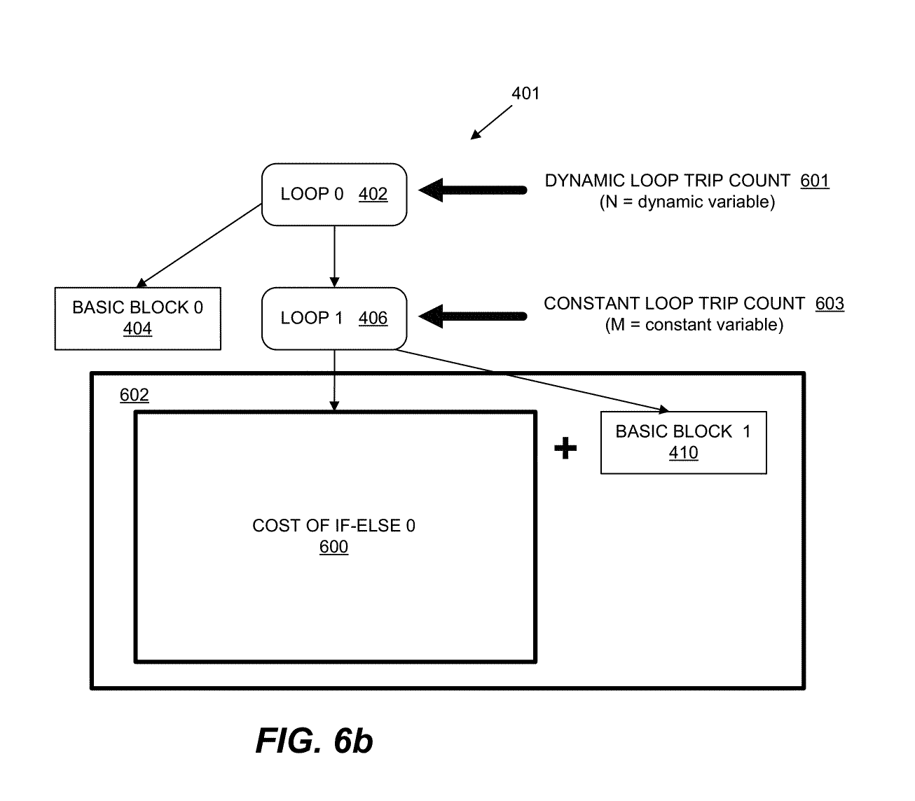

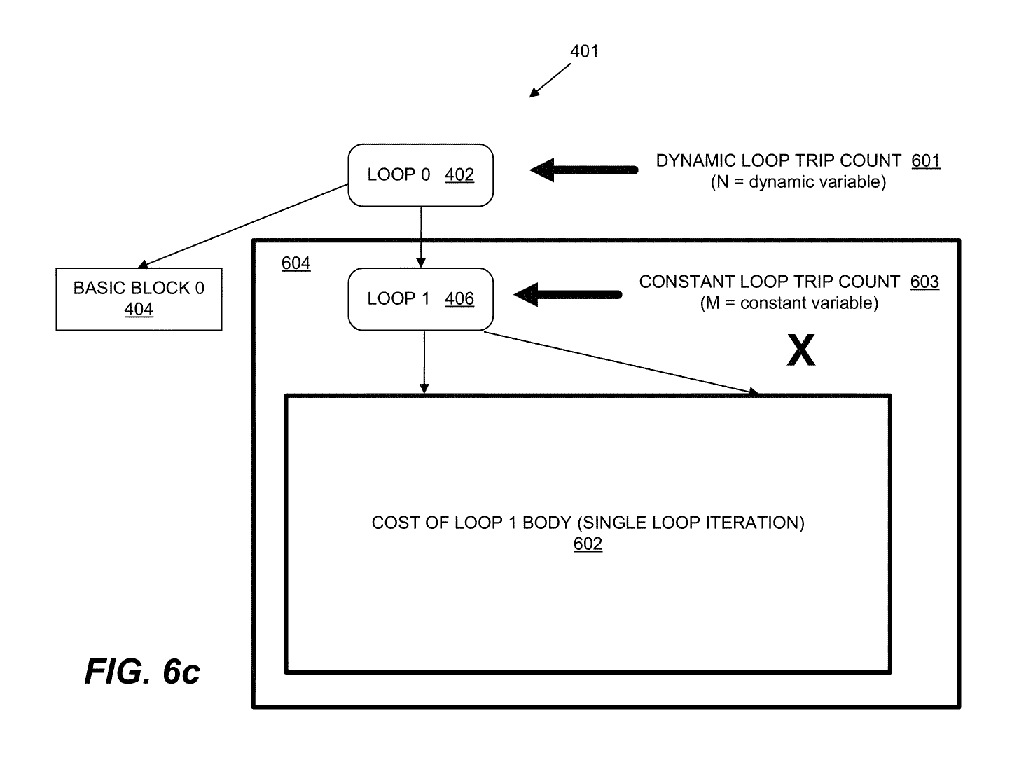

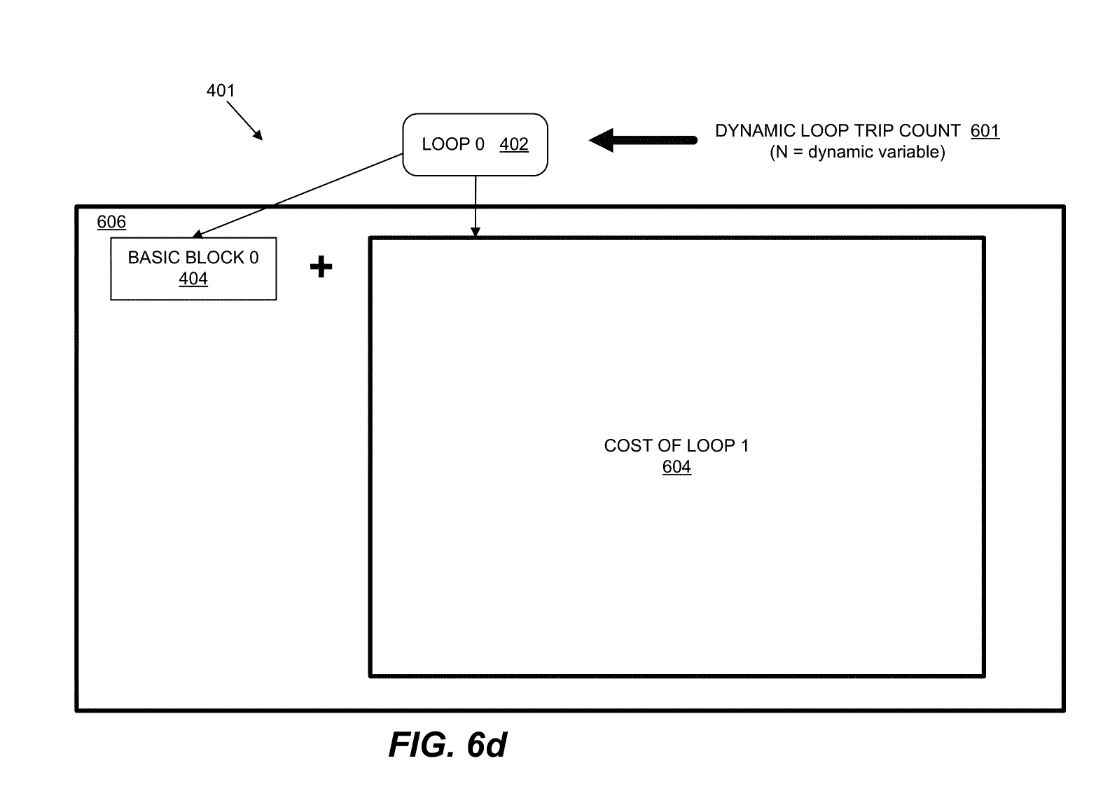

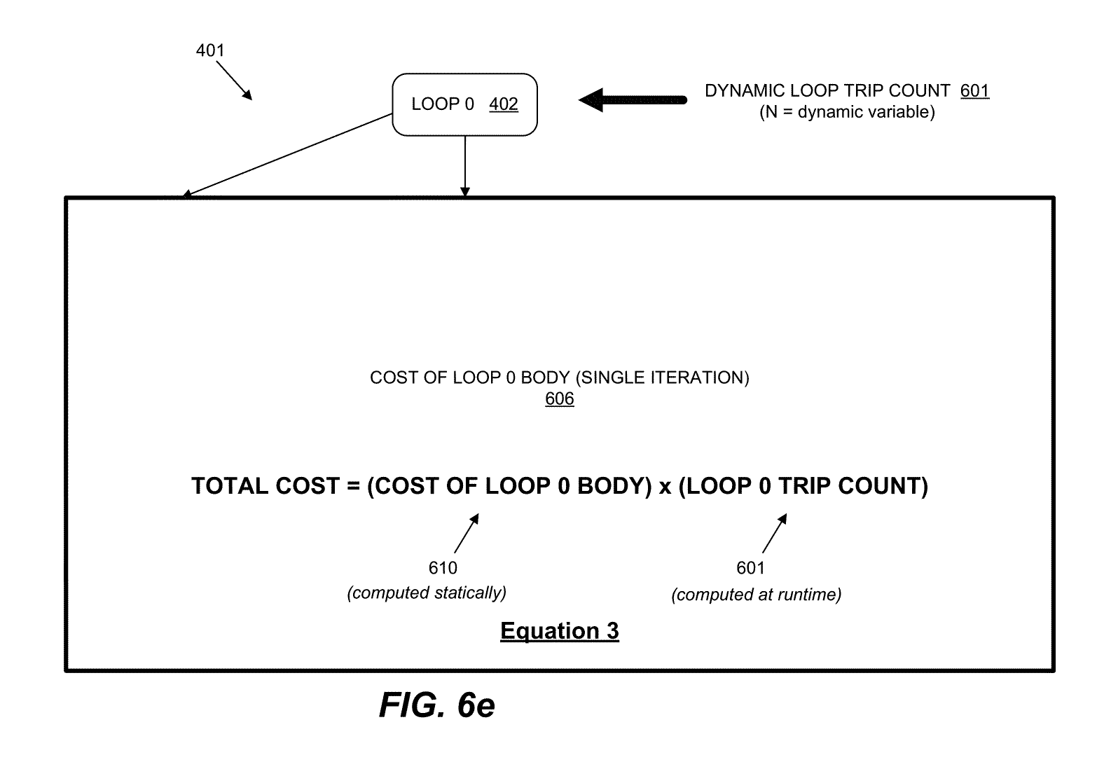

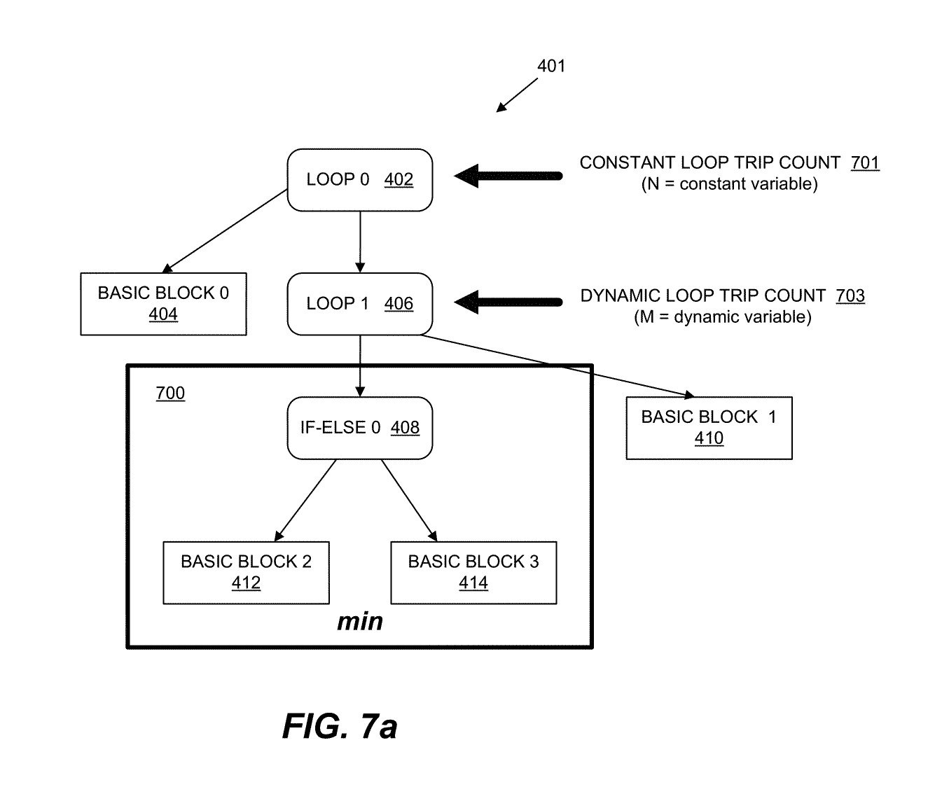

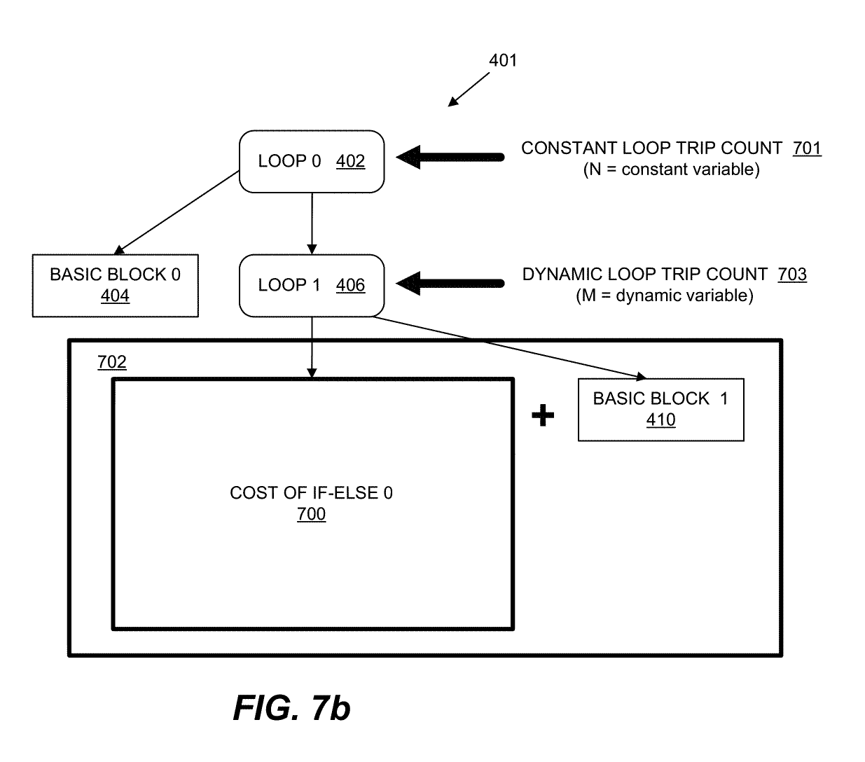

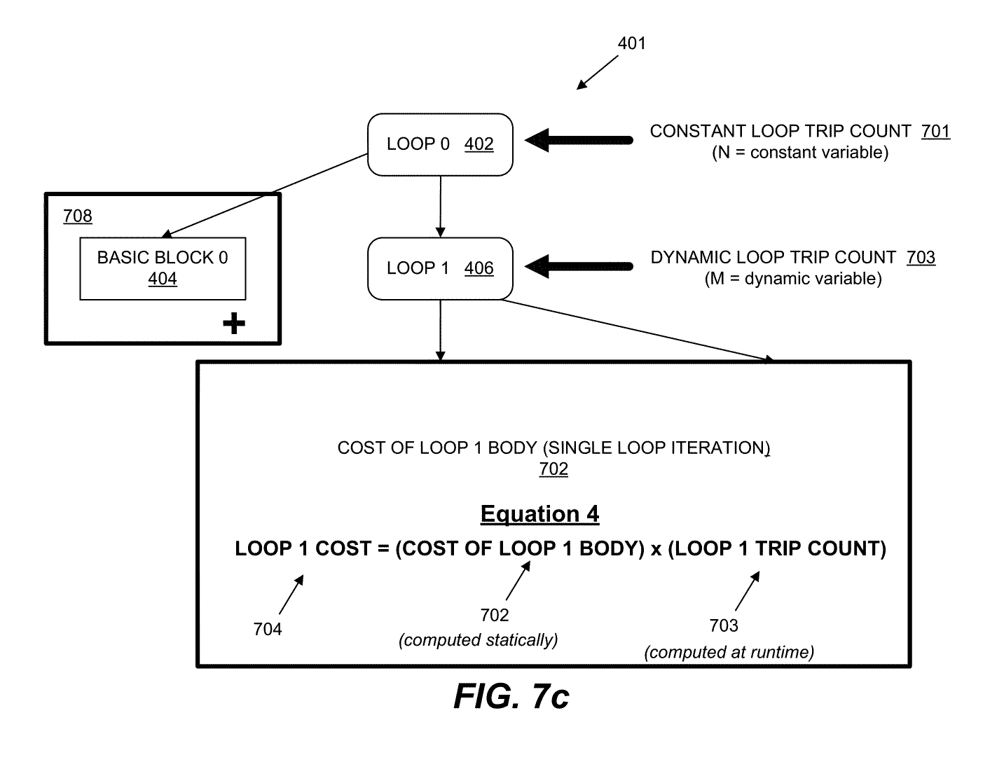

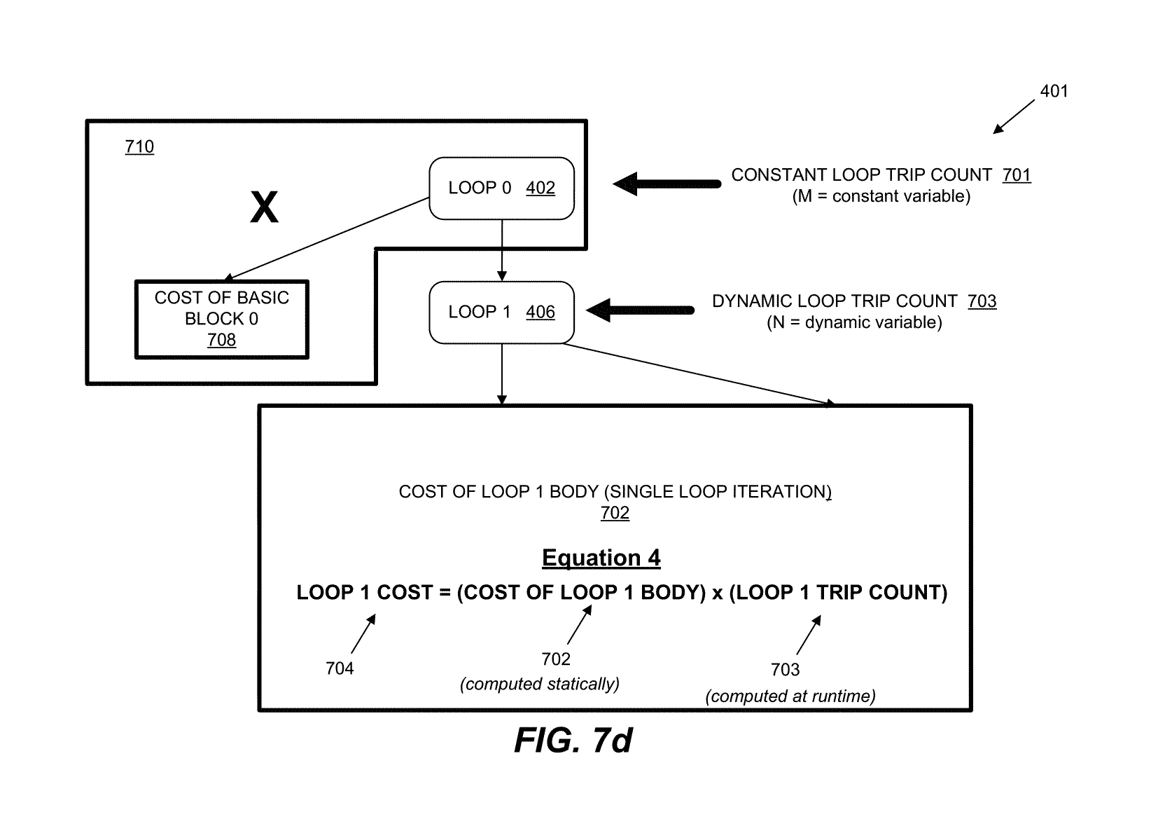

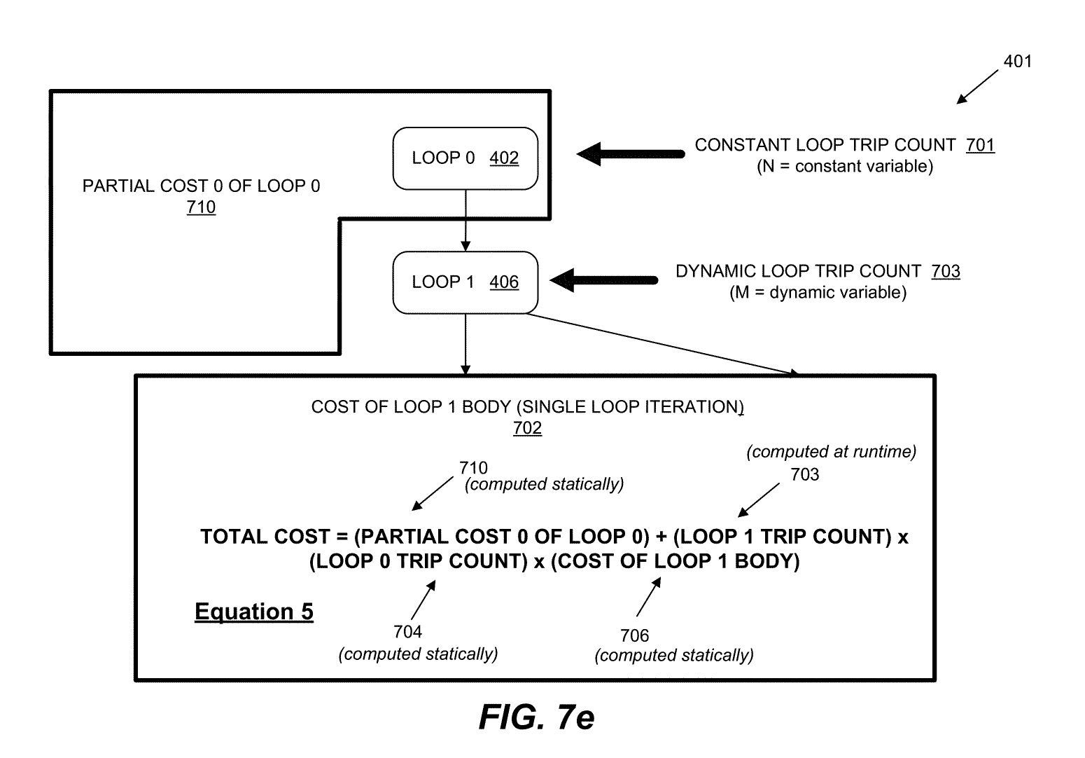

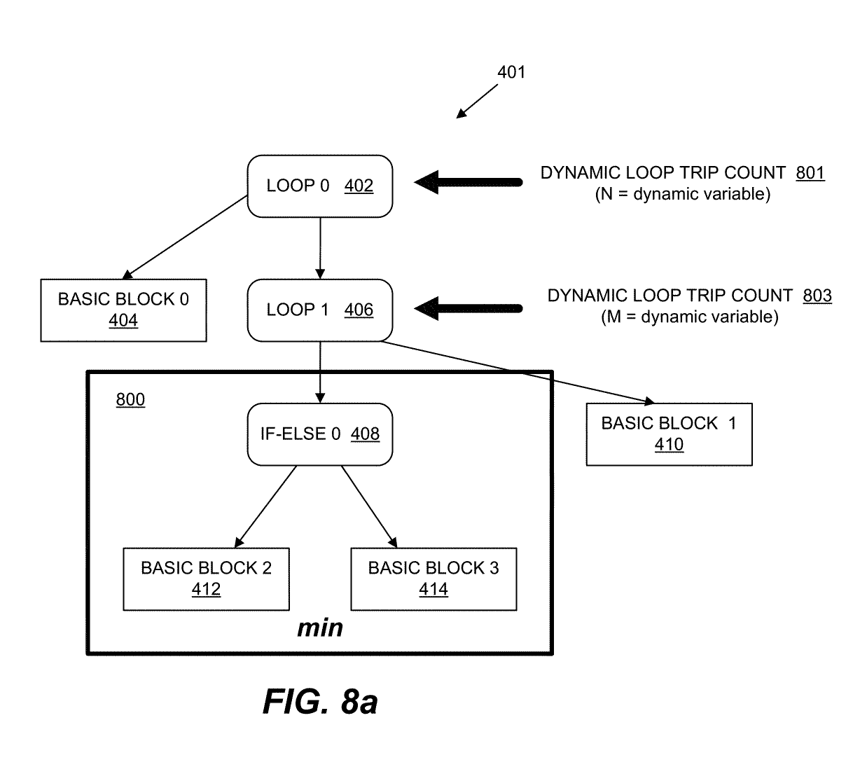

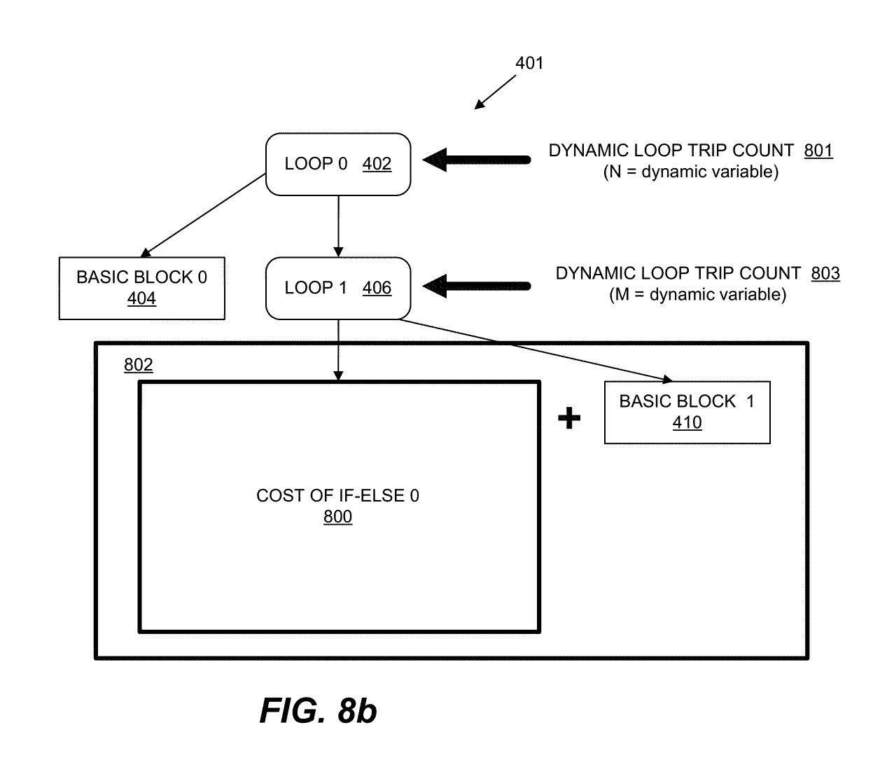

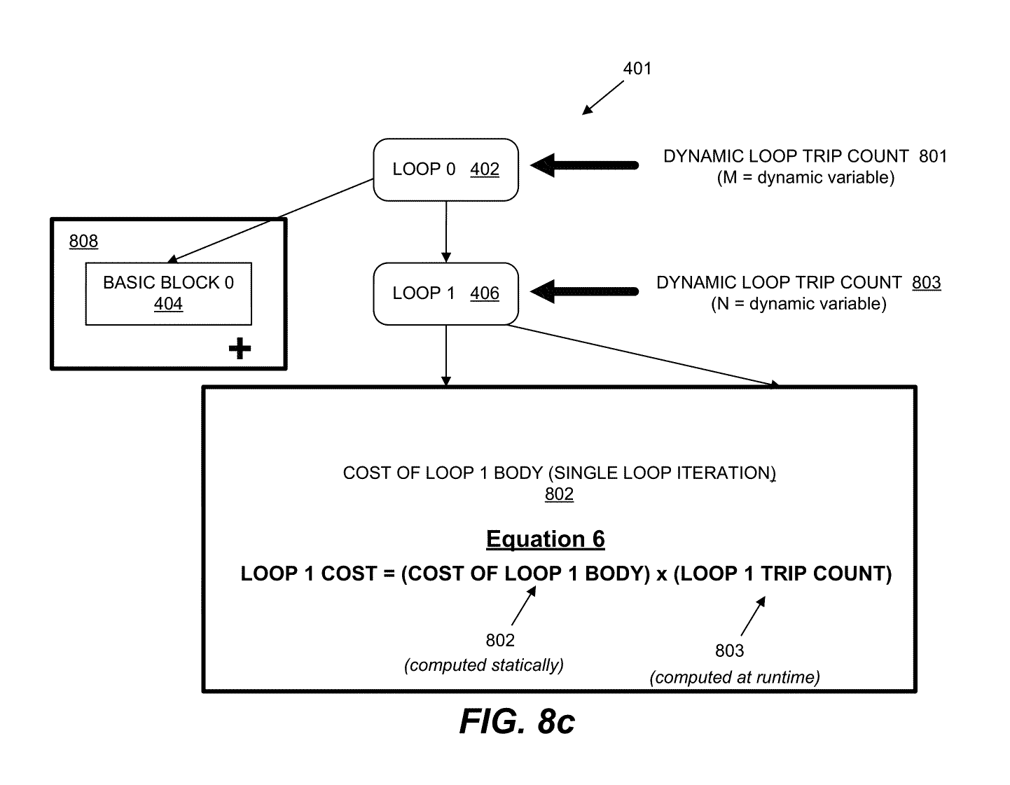

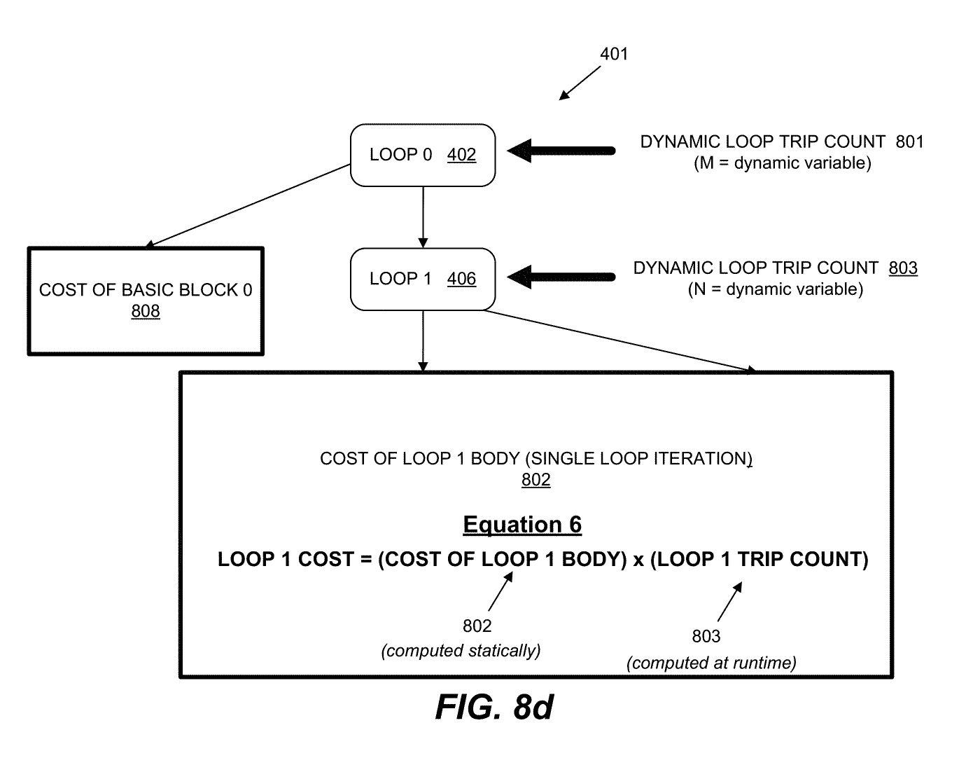

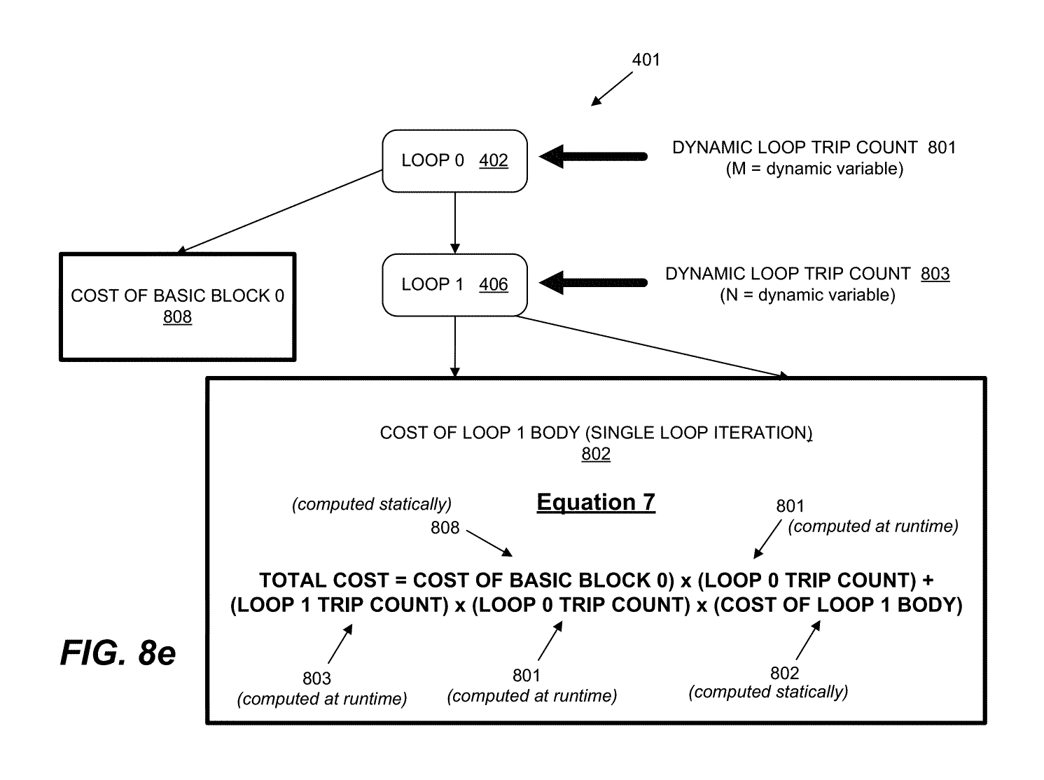

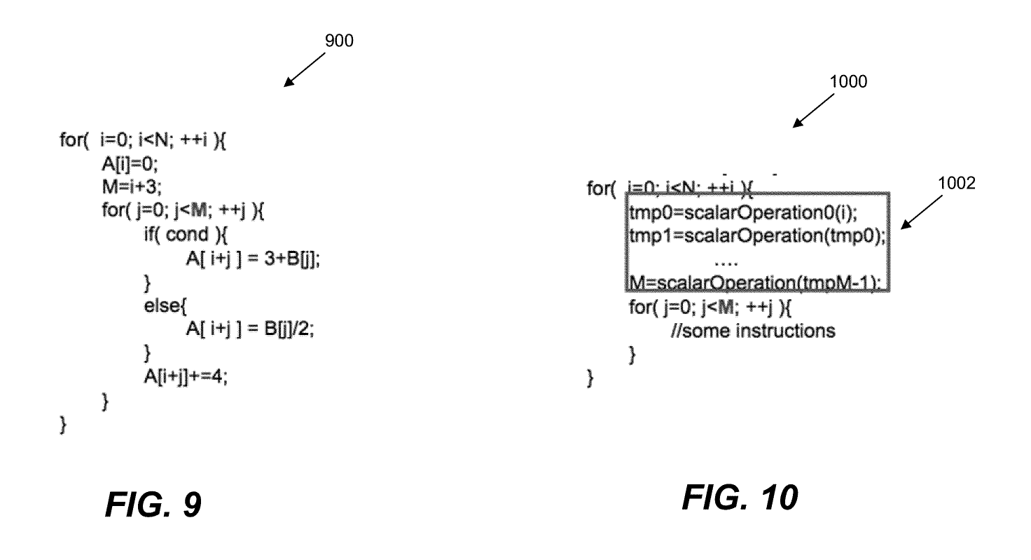

As mentioned above, there are situations in which the control flow construction of the DAG 401 does not enable all of the loop trip counts to be statically resolved. In these instances, a portion of the code cost may be automatically computed at runtime by generating the code cost computation expression 144 (at compile time) and injecting it in the application code 124. Referring again to the exemplary code 400 illustrated in FIG. 4a, the code being analyzed by the CCA modules 122 may comprise loops with constant trip counts and dynamic trip counts. Four examples will be described to illustrate the various ways in which the code cost computation expression 144 and the runtime profitability check 140 may be implemented. FIGS. 6a-6e illustrate a first example in which the outer loop 402 (Loop 402) comprises a dynamic loop trip count 601 (i.e., N=a dynamic variable) and the inner loop 406 comprises a constant loop trip count 603 (i.e., M=a constant variable). FIGS. 7a-7f illustrate a second example in which the outer loop 402 (Loop 402) comprises a constant loop trip count 701 (i.e., N=a constant variable) and the inner loop 406 comprises a dynamic loop trip count 703 (i.e., M=a dynamic variable). FIGS. 8a-8e illustrate a third example in which the outer loop 402 (Loop 402) comprises a dynamic loop trip count 801 (i.e., N=a dynamic variable) and the inner loop 406 comprises a dynamic loop trip count 803 (i.e., M=a dynamic variable). A fourth example will be described with reference to FIGS. 9-16. In the embodiment of FIGS. 9-16, the outer loop has a constant trip count and the inner loop has a trip count that is defined in the body of the outer loop. The trip count of the inner loop is dynamic, is defined by the outer loop body, and varies for different outer loop iterations. One of ordinary skill in the art will appreciate that additional use cases may be implemented. For example, a fifth exemplary use case may comprise a variation of the fourth example where the outer loop has a dynamic trip count and the inner loop trip count is defined in the body of the outer loop. Further combinations of these and other use cases may be supported.

Referring to the first example (FIGS. 6a-6e), the cost of If-Else 0 408 is computed as the minimum cost (cost 600) of Basic Block 2 (cost 412) and Basic Block 3 (cost 414). In FIG. 6b, the cost of a single loop iteration of Loop 1 Body (cost 602) is computed as the sum of cost 600 for If-Else 0 and the cost of Basic Block 1 (cost 410). In FIG. 6c, the cost of Loop 1 (cost 604) is computed by multiplying cost 602 (i.e., a single loop iteration of Loop 1 Body) by the Loop 1 Constant Trip Count 603. In FIG. 6d, the cost of a single loop iteration of Loop 0 Body (cost 606) is computed as the sum of cost 604 and the cost of Basic Block 0 (cost 404). In FIG. 6e, the total cost of Loop 0 may be computed by multiplying cost 606 (i.e., a single loop iteration of Loop 0 Body) by the Loop 0 Dynamic Trip Count 601. In this manner, the total cost of Loop 0 may be expressed according to Equation 3 (FIG. 6e) with cost 610 (cost of Loop 0 Body) being computed statically and Loop 0 Dynamic Trip Count 601 being computed at runtime. The total cost may be computed at runtime by combining costs 610 and 601.

Referring to the second example (FIGS. 7a-7f), the cost of If-Else 0 408 is computed as the minimum cost (cost 700) of Basic Block 2 (cost 412) and Basic Block 3 (cost 414). In FIG. 7b, the cost of a single loop iteration of Loop 1 Body (cost 702) is computed as the sum of cost 700 for If-Else 0 and the cost of Basic Block 1 (cost 410). In FIG. 7c, the cost of Loop 1 (cost 704) may be computed by multiplying cost 702 (i.e., a single loop iteration of Loop 1 Body) by the Loop 1 Dynamic Trip Count 703. In this manner, cost 704 may be expressed according to Equation 4 (FIG. 7c) with cost 702 being computed statically and Loop 1 Dynamic Trip Count 703 being computed at runtime. It should be appreciated that Loop 1 Cost (cost 704) may be computed dynamically. As illustrated in FIG. 7d, an embodiment of a method may partially, statically work on Loop 0 cost. A Partial Cost 0 of Loop 0 (cost 710) may be determined statically by multiplying the cost of Basic Block 0 (cost 708) with the constant trip count 701 of Loop 0. Equation 5 in FIG. 7e represents the computation of the total cost for the example code. The total cost equals to the sum of partial cost 0 of Loop 0 (cost 710) plus Loop 1 Trip Count 703 multiplied by Loop 0 Trip Count 704 and the resulting product multiplied by the cost of Loop 1 Body (cost 706). It should be appreciated that costs 710, 704 and 706 may be computed statically and cost 703 may be computed at runtime.

Referring to the third example (FIGS. 8a-8e), in FIG. 8a, the cost of If-Else 0 is computed as the minimum cost (cost 800) of Basic Block 2 (cost 412) and Basic Block 3 (cost 414). In FIG. 8b, the cost of a single loop iteration of Loop 1 Body (cost 802) is computed as the sum of cost 800 for If-Else 0 and the cost of Basic Block 1 (cost 410). Loop 1 has a dynamic trip count 803 so its cost cannot be computed statically. In FIG. 8c equation 6 represents the cost of Loop 1 as the cost of a single loop iteration (cost 802) multiplied the dynamic Loop 1 Trip Count 803. In FIG. 8d, CCA module 122 may statically compute the cost of Basic Block 0 (404) shown as cost 808. In FIG. 8e, equation 7 represents the total cost for the code example, which is equal to the cost of Basic Block 0 (Cost 808) multiplied by the Loop 0 Trip Count 801 plus Loop 1 Trip Count 803 multiplied by Loop 0 Trip Count 801 multiplied by Cost of Loop 1 Body (Cost 802). Costs 802 and 808 may be statically computed, and costs 801 and 803 may be computed dynamically.

Referring to FIGS. 9-16, additional examples will be described to illustrate further embodiments for implementing runtime cost computation in situations in which inner loop trip counts are dependent on outer loops. FIG. 9 illustrates exemplary application code 900 in which a trip count of an inner loop (M) is defined in an outer loop body. In this example, the number of iterations of the inner loop may vary across the outer loop iterations. FIG. 10 illustrates generalized application code 1000 representing a general loop dependence. In this example, it should be appreciated that values for the inner loop trip count may be represented as an arithmetic sequence. Box 1002 highlights a code portion comprising a chain of scalar instructions in the outer loop body which define “M”. This instruction chain may depend only on an induction variable of the outer loop and loop invariant values. The sequence of values of M may be represented as an arithmetic sequence wherein each term may calculated according to Equation 8 below:

aₙ=a₁+(n−1)d Equation 8

The total number of iterations for the inner loop may be equal to the sum of the arithmetic sequence for its first N terms. The total number of iterations of the inner loop may be represented according to Equation 9 below:

Sₙ=[n(a₁+aₙ)]/2; wherein
n=N
a₁ is ComputeChainForIV(0), the value of M for the outerloop iteration with IV=0
aₙ is ComputeChainForW(N), the value of M for the outer loop iteration with IV=n

### Equation 9

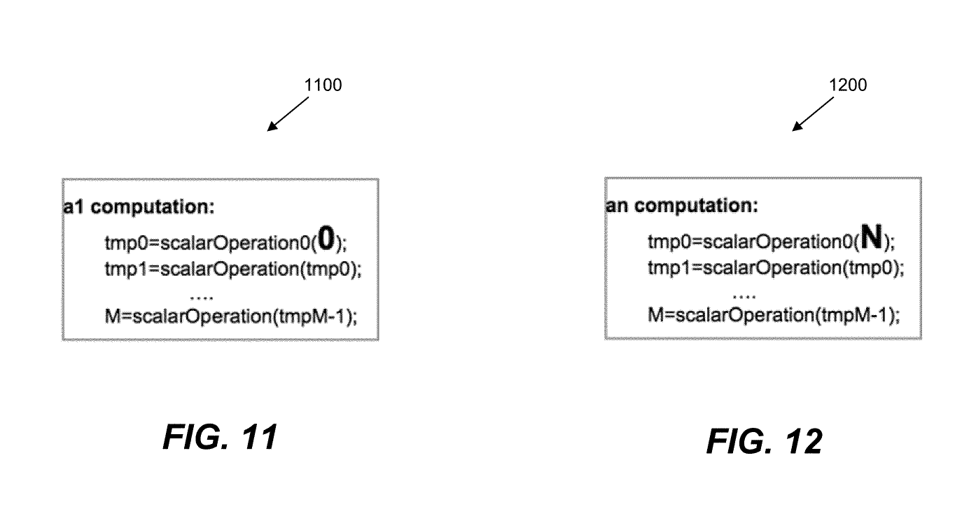

FIG. 11 illustrates the code 1100 for computation a₁. FIG. 12 illustrates the code 1200 for computation aₙ.

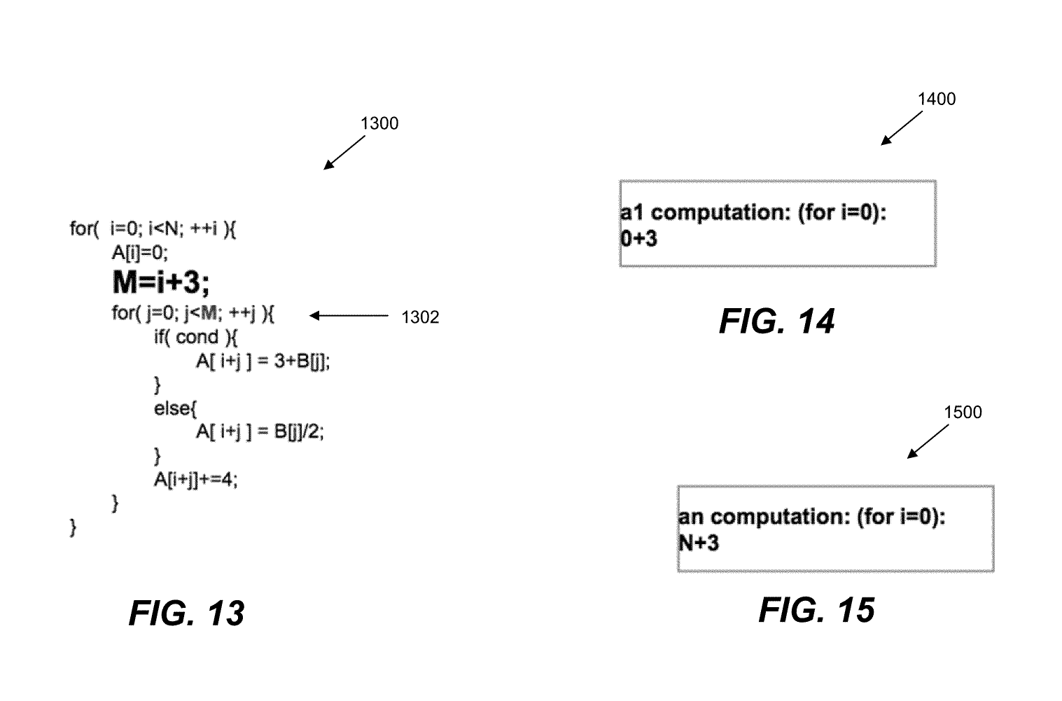

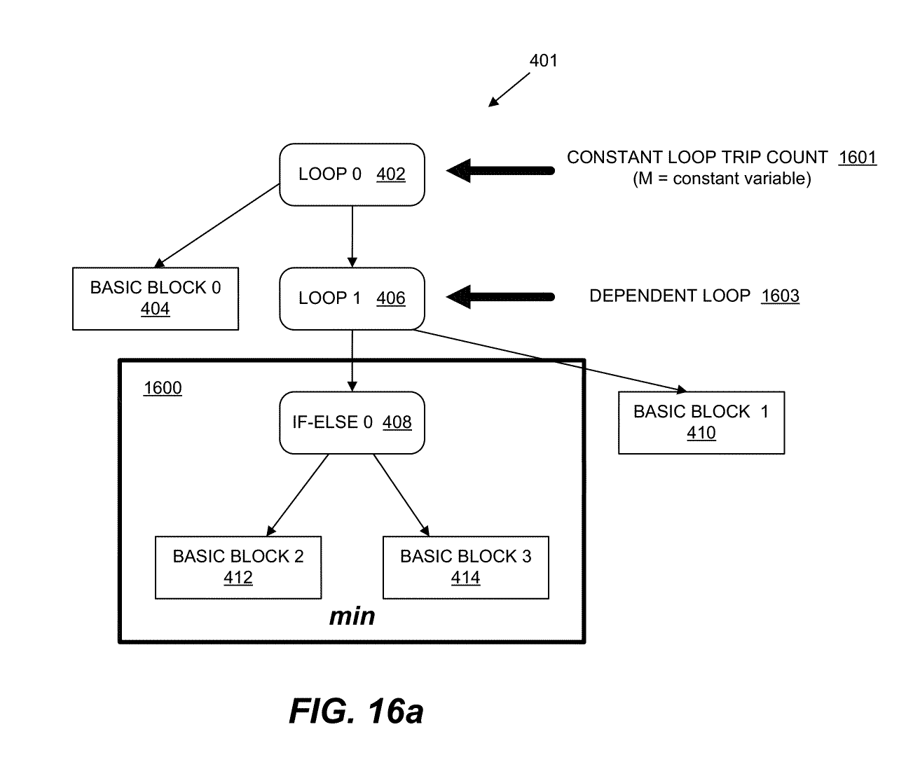

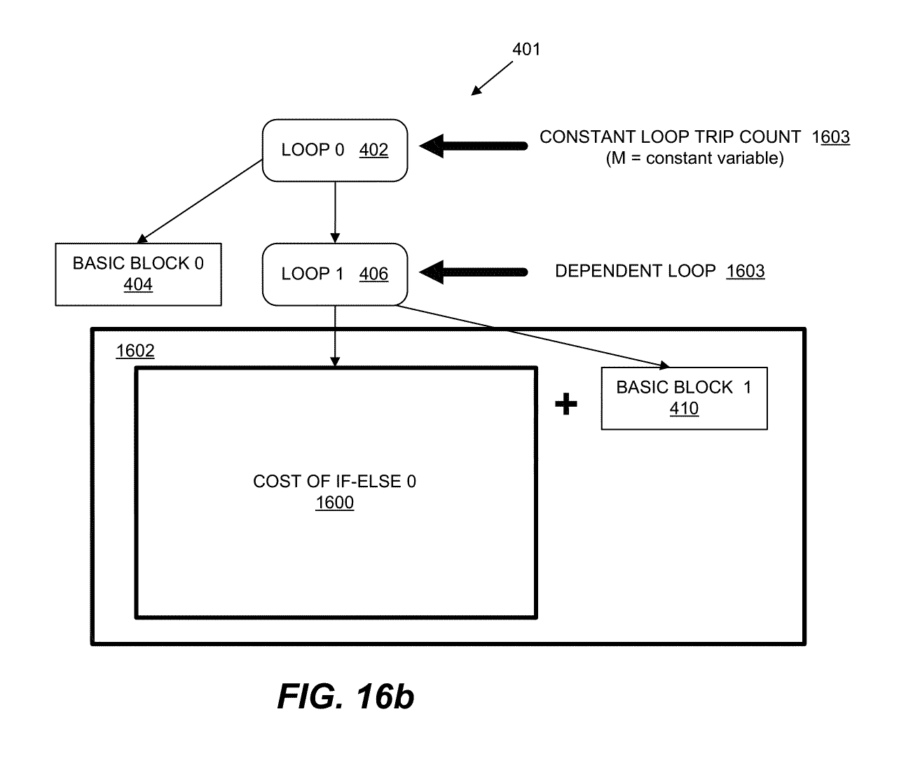

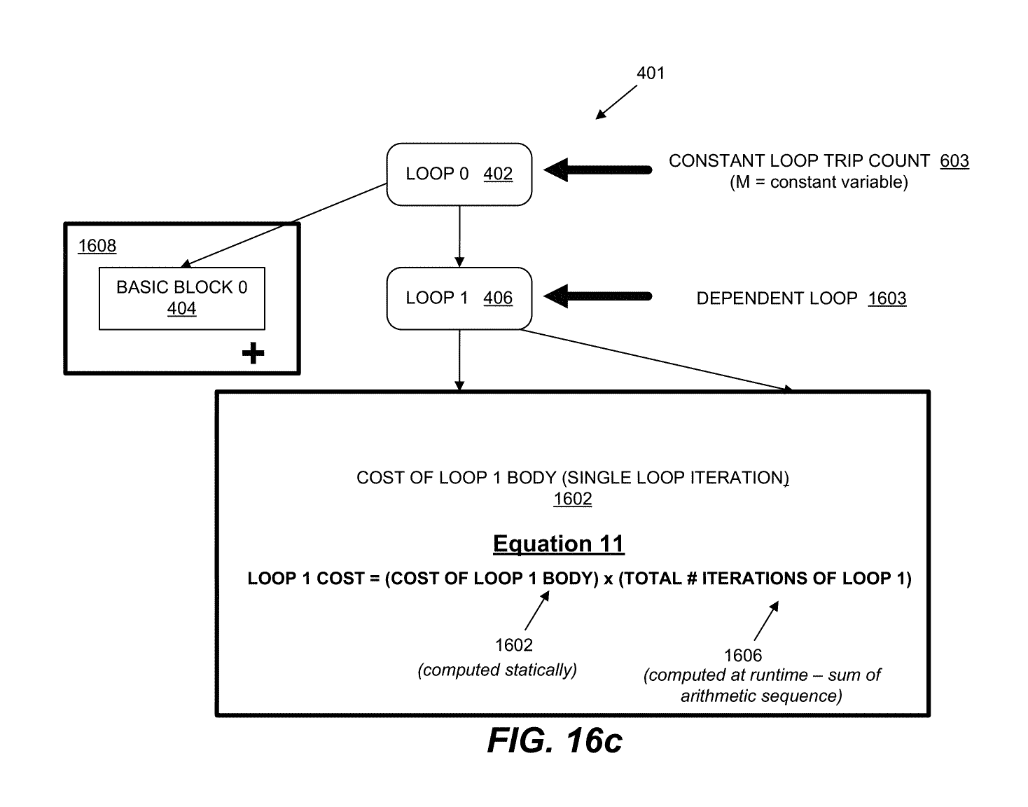

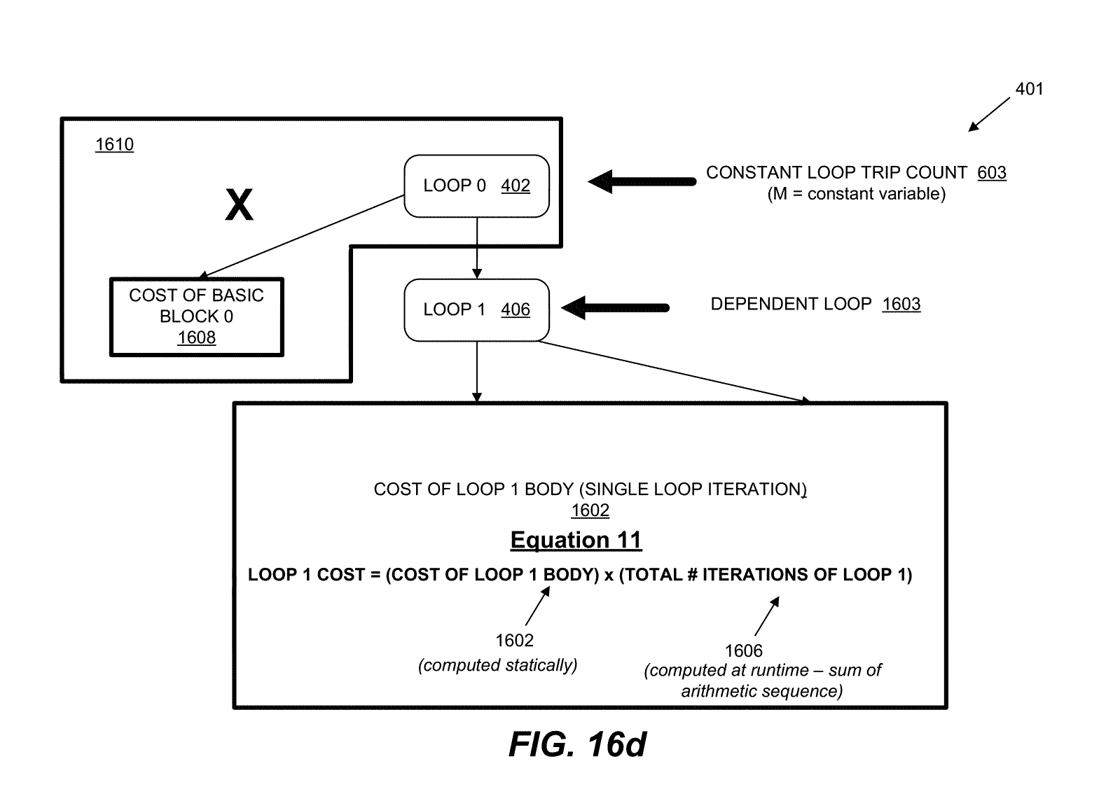

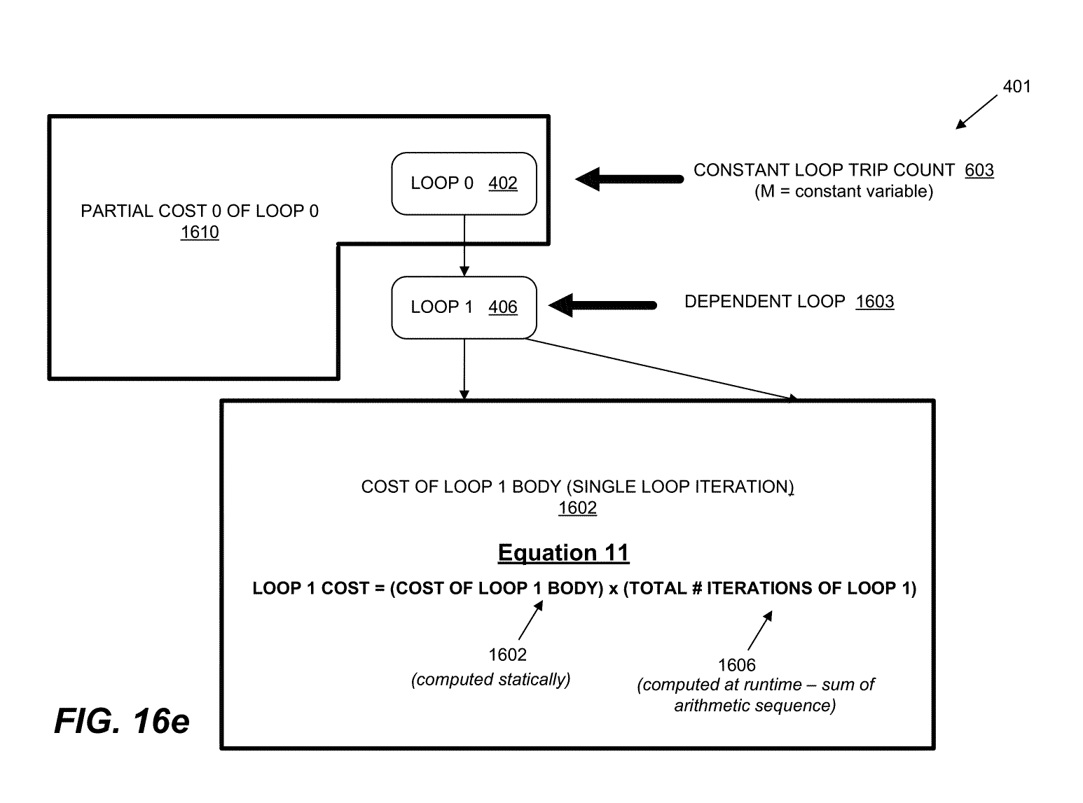

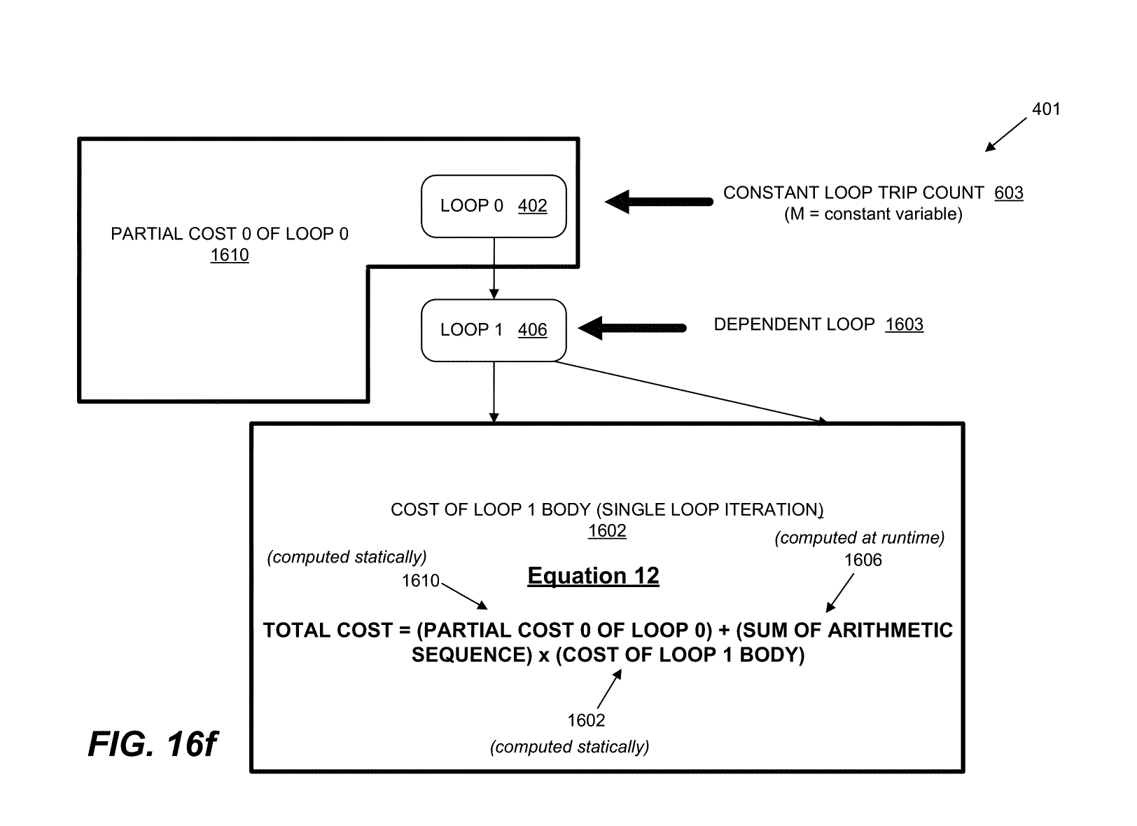

FIGS. 13-15 illustrate another embodiment of exemplary code 1300 in which the trip count values for an inner loop 1302 may be represented as an arithmetic sequence. In FIG. 13, the trip count of the inner Loop “M” is defined in the outer loop body with the statement “M=i+3”. FIG. 14 illustrates the code 1400 for computation a₁ by specializing the code of FIG. 11. FIG. 15 illustrates the code 1500 for computation aₙ by specializing the code of FIG. 12. In this example, the total iterations of inner loop 1302 may be represented according to Equation 10 below:

Sₙ=N*(3+N+3)/2 Equation 10

Equation 10 is the specialization of Equation 9 on the example case.

FIGS. 16a-16f illustrate a further example in which the code cost computation expression 144 and the runtime profitability check 140 may support the inner loop dependency discussed above. This example references the same DAG 401 in which inner Loop 1 comprises a dependent loop 1603 and the outer Loop 0 has a constant loop trip count 1601. In FIG. 16a, the cost of If-Else 0 (cost 1600) is computed as the minimum cost of Basic Block 2 (cost 412) and Basic Block 3 (cost 414). In FIG. 6b, the cost of a single loop iteration of Loop 1 Body (cost 1602) is computed as the sum of cost 1600 for If-Else 0 and the cost of Basic Block 1 (cost 410). Loop 1 has Trip Count 1603 dependent on the outer Loop and we represent the total number of inner loop iterations as the sum of an arithmetic sequence as we described above. Equation 11 in FIG. 16c represents the total cost of Loop 1 that equals to the cost of Loop Body 1 (1602) multiplied by the total number of iterations of Loop 1 (1606). This computation may be only completed at runtime so CCA modules 122 may not proceed statically. In FIG. 16d, the CCA modules 122 may proceed by statically calculating the cost of Basic Block 0 (404) illustrated as cost 1608. In FIG. 16e, the partial cost 0 of Loop 0 (1610) is calculated by multiplying Cost 1608 by Loop 0 Trip Count 603. This computation may be done statically. Equation 12, in FIG. 16f, represents the total cost of the example code. The total cost equals to the sum of Partial Cost 0 of Loop 0 (Cost 1610) plus the value of Equation 11 in FIG. 16e. It should be appreciated that Equation 11 represents the total number of iterations of Loop 1, which is the reason that the Loop 1 cost may be calculated without multiplying by the outer Loop Trip Count in Equation 11.

It should be appreciated that, if profiling information about loop execution is available and there is a profiled trip count value, the following approach may be implemented. In presence of profiling information, for loops with dynamic trip counts the profiled trip counts may be used and the cost of the loop may be estimated as it would be by having a static trip count. In this regard, there may be two scenarios. First, if the loop can be determined profitable based on the profiled trip count value, the loop may be treated as having a static trip count in which case the trip count of the loop is static. Second, if the profiled trip count does not indicate that the code is profitable for parallelization, the profiled information may be ignored. In this regard, the cost estimation and profitability may be applied with the above-described techniques for loops with dynamic trip counts. One of ordinary skill in the art will appreciate that other methods and techniques may be implemented. In an embodiment, the above-described methods and techniques may be modified to accommodate different profitability needs and/or performance strategies.

The system 100 may be incorporated into any desirable computing system. FIG. 18 illustrates the system 100 incorporated in an exemplary portable computing device (PCD) 1800. A system-on-chip (SoC) 113 may include the runtime environment 141 and the processors 126. A display controller 328 and a touch screen controller 1806 may be coupled to the processors 126. In turn, the touch screen display 1806 external to the on-chip system 103 may be coupled to the display controller 328 and the touch screen controller 330.

FIG. 18 further shows that a video encoder 334, e.g., a phase alternating line (PAL) encoder, a sequential color a memoire (SECAM) encoder, or a national television system(s) committee (NTSC) encoder, may be coupled to one or more of the processor clusters 102, 104, and 106. Further, a video amplifier 336 is coupled to the video encoder 334 and the touch screen display 1806. Also, a video port 338 is coupled to the video amplifier 336. As shown in FIG. 18, a universal serial bus (USB) controller 340 is coupled to one or more of the processor clusters. Also, a USB port 342 is coupled to the USB controller 340. Memory 104 and a subscriber identity module (SIM) card 346 may also be coupled to the processors 126.

A digital camera 348 may be coupled to the processors 126. In an exemplary aspect, the digital camera 348 is a charge-coupled device (CCD) camera or a complementary metal-oxide semiconductor (CMOS) camera. A stereo audio coder-decoder (CODEC) 350 may be coupled to the processors 126. Moreover, an audio amplifier 352 may coupled to the stereo audio CODEC 350. In an exemplary aspect, a first stereo speaker 354 and a second stereo speaker 356 are coupled to the audio amplifier 352. A microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 18 further illustrates that a radio frequency (RF) transceiver 368 may be coupled to the processors 126. An RF switch 370 may be coupled to the RF transceiver 368 and an RF antenna 372. A keypad 204, a mono headset with a microphone 376, and a vibrator device 378 may be coupled to the processors 126.

FIG. 18 also shows that a power supply 380 may be coupled to the on-chip system 113. In a particular aspect, the power supply 380 is a direct current (DC) power supply that provides power to the various components of the PCD 1800 that require power. Further, in a particular aspect, the power supply is a rechargeable DC battery or a DC power supply that is derived from an alternating current (AC) to DC transformer that is connected to an AC power source.

FIG. 18 further indicates that the PCD 1800 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

Referring to FIG. 18, it should be appreciated that the memory 104, touch screen display 1806, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 113.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously) with other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for performing runtime auto-parallelization of application code, the method comprising:
receiving application code to be executed in a multi-processor system, the application code comprising an injected code cost computation expression for at least one loop in the application code defining a serial workload for processing the loop;
performing a runtime profitability check of the loop based on the injected code cost computation expression to determine whether the serial workload can be profitably parallelized; and
if the serial workload can be profitably parallelized, executing the loop in parallel using two or more processors in the multi-processor system.

2. The method of claim 1, wherein the performing the runtime profitability check comprises:
computing a parallelized workload based on an available number of processors; and
determining whether a sum of the parallelized workload and a parallelization overhead parameter exceeds the serial workload.

3. The method of claim 1, wherein the injected code cost computation expression defines a first static portion of the serial workload defined at compile time and a second dynamic portion of the serial workload to be computed at runtime.

4. The method of claim 3, wherein the performing the runtime profitability check comprises:
computing the second dynamic portion of the serial workload; and
defining the serial workload as a sum of the first static portion and the second dynamic portion.

5. The method of claim 4, wherein the runtime profitability check further comprises determining whether parallelizing the serial workload exceeds a breakeven point based on a parallelization overhead parameter.

6. The method of claim 1, wherein the performing the runtime profitability check comprises determining profiling information related to behavior of the application code.

7. The method of claim 1, further comprising:
if the serial workload cannot be profitably parallelized, executing the loop in serial using only one of the two or more processors in the multi-processor system.

8. The method of claim 1, wherein the injected code cost computation expression is computed by a code cost analysis algorithm at compile time.

9. The method of claim 8, wherein the code cost analysis algorithm computes the code cost computation expression by constructing a directed acyclic graph for the loop.

10. The method of claim 1, wherein the multi-processor system is incorporated in a portable computing device comprising one or more of a mobile phone, a tablet computer, a gaming device, and a navigation device, and the multi-processor system comprises a plurality of processors comprising one or more of a multi-core processor, a central processing unit (CPU), a graphics processor unit (GPU), and a digital signal processor (DSP).

11. A system for performing runtime auto-parallelization of application code, the method comprising:
means for receiving application code to be executed in a multi-processor system, the application code comprising an injected code cost computation expression for at least one loop in the application code defining a serial workload for processing the loop;
means for performing a runtime profitability check of the loop based on the injected code cost computation expression to determine whether the serial workload can be profitably parallelized; and
means for executing the loop in parallel using two or more processors in the multi-processor system if the serial workload can be profitably parallelized.

12. The system of claim 11, wherein the means for performing the runtime profitability check comprises:
means for computing a parallelized workload based on an available number of processors; and
means for determining whether a sum of the parallelized workload and a parallelization overhead parameter exceeds the serial workload.

13. The system of claim 11, wherein the injected code cost computation expression defines a first static portion of the serial workload defined at compile time and a second dynamic portion of the serial workload to be computed at runtime.

14. The system of claim 13, wherein the means for performing the runtime profitability check comprises:
means for computing the second dynamic portion of the serial workload; and
means for defining the serial workload as a sum of the first static portion and the second dynamic portion.

15. The system of claim 14, wherein the runtime profitability check further comprises means for determining whether parallelizing the serial workload exceeds a breakeven point based on a parallelization overhead parameter.

16. The system of claim 11, wherein the means for performing the runtime profitability check comprises means for determining profiling information related to behavior of the application code.

17. The system of claim 11, further comprising:
means for executing the loop in serial using only one of the two or more processors in the multi-processor system if the serial workload cannot be profitably parallelized.

18. The system of claim 11, wherein the injected code cost computation expression is computed by a code cost analysis algorithm at compile time.

19. The system of claim 18, wherein the code cost analysis algorithm computes the code cost computation expression by constructing a directed acyclic graph for the loop.

20. The system of claim 11, wherein the multi-processor system is incorporated in a portable computing device comprising one or more of a mobile phone, a tablet computer, a gaming device, and a navigation device, and the multi-processor system comprises a plurality of processors comprising one or more of a multi-core processor, a central processing unit (CPU), a graphics processor unit (GPU), and a digital signal processor (DSP).

21. A computer program embodied in a computer-readable medium and executable by a processor for performing runtime auto-parallelization of application code, the computer program comprising logic configured to:
receive application code to be executed in a multi-processor system, the application code comprising an injected code cost computation expression for at least one loop in the application code defining a serial workload for processing the loop;
perform a runtime profitability check of the loop based on the injected code cost computation expression to determine whether the serial workload can be profitably parallelized; and
if the serial workload can be profitably parallelized, execute the loop in parallel using two or more processors in the multi-processor system.

22. The computer program of claim 21, wherein the logic configured to perform the runtime profitability check comprises logic configured to:
compute a parallelized workload based on an available number of processors; and
determine whether a sum of the parallelized workload and a parallelization overhead parameter exceeds the serial workload.

23. The computer program of claim 21, wherein the injected code cost computation expression defines a first static portion of the serial workload defined at compile time and a second dynamic portion of the serial workload to be computed at runtime.

24. The computer program of claim 23, wherein the logic configured to perform the runtime profitability check comprises logic configured to:
compute the second dynamic portion of the serial workload; and
define the serial workload as a sum of the first static portion and the second dynamic portion.

25. The computer program of claim 24, wherein the logic configured to perform the runtime profitability check further comprises logic configured to determine whether parallelizing the serial workload exceeds a breakeven point based on a parallelization overhead parameter.

26. A system for performing runtime auto-parallelization of application code, the system comprising:
a plurality of processors; and
a runtime environment configured to execute application code via one or more of the plurality of processors, the runtime environment comprising an auto-parallelization controller configured to:
receive the application code to be executed via one or more of the processors, the application code comprising an injected code cost computation expression for at least one loop in the application code defining a serial workload for processing the loop;
perform a runtime profitability check of the loop based on the injected code cost computation expression to determine whether the serial workload can be profitably parallelized; and
if the serial workload can be profitably parallelized, execute the loop in parallel using two or more processors.

27. The system of claim 26, wherein the runtime profitability check comprises:
computing a parallelized workload based on an available number of processors; and
determining whether a sum of the parallelized workload and a parallelization overhead parameter exceeds the serial workload.

28. The system of claim 26, wherein the injected code cost computation expression defines a first static portion of the serial workload defined at compile time and a second dynamic portion of the serial workload to be computed at runtime.

29. The system of claim 28, wherein the runtime profitability check comprises:
computing the second dynamic portion of the serial workload; and
defining the serial workload as a sum of the first static portion and the second dynamic portion.

30. The system of claim 29, wherein the runtime profitability check further comprises determining whether parallelizing the serial workload exceeds a breakeven point based on a parallelization overhead parameter.
